(19) United States
(12) Patent Application Publication
(10) Pub. No.: US 2005/0273300 A1
(43) Pub. Date: Dec. 8, 2005

(54) Method and system for water flow analysis

(76) Inventors: Avinash S. Patwardhan, Wellington, FL (US); Thomas Jobes, Atlanta, GA (US); Jared N. Thorpe, Gainesville, FL (US); Sharook Madon, San Diego, CA (US)

Correspondence Address: PERKINS COIE LLP;PATENT-SEA, P.O. BOX 1247, SEATTLE, WA, 98111-1247, US

(21) Appl. No.: 11/137,106

(22) Filed: May 24, 2005

Related U.S. Application Data
(63) Continuation-in-part of application No. 10/675,911, filed on Sep. 29, 2003.
(60) Provisional application No. 60/573,938, filed on May 24, 2004.

(51) Int. Cl. G06G 7/48

(52) U.S. Cl. 703/9

(57) ABSTRACT

A method and system for modeling water flow quantity, quality, and fish biogenetics of a watershed restoration project. The modeling system allows a user to create a graphical representation of the different areas of a development site design. The graphical representation shows the water flows (quantity and quality) between the different areas. The user may also specify the attributes of each area, such as rate of infiltration, runoff coefficient, size, rate of evapotranspiration, and so on. The modeling system can simulate the impact of rainfall on the development design. The simulation determines the inflow (quantity and quality) of water to each area and determines the outflow (quantity and quality) of water for each area. The results of this simulation can be used to evaluate the development design and adjust the design to achieve the desired cost-benefit balance of the watershed protection criteria of choice.

### CROSS-REFERENCE TO RELATED APPLICATION(S)

This application is a continuation-in-part of U.S. patent application Ser. No. 10/675,911, filed on Sep. 29, 2003, and entitled “Method and System for Water Flow Analysis,” and claims the benefit of U.S. Provisional Patent Application No. 60/573,938, filed on May 24, 2004, and entitled “Method and System for Water Flow Analysis,” which are hereby incorporated by reference.

### TECHNICAL FIELD

The described technology relates to analysis of stormwater management control at a development site or at different scales within a watershed.

### BACKGROUND

Land development generally alters the natural water balance of a site. When natural vegetation and soils are replaced with roads and buildings, less rainfall infiltrates into the ground, and more rainfall becomes surface runoff.

To minimize flooding at a site, traditional ditch and pipe systems have been designed to remove stormwater runoff from impervious surfaces as quickly as possible, and deliver it to receiving waters. As a result, stormwater runoff arrives at the receiving waters much faster and in greater volume than under natural conditions. This speed and volume causes channel erosion, flooding, loss of aquatic habitat, and water quality degradation. If these impacts are not avoided, there can be environmental, legal, financial, and political implications, and so on.

“Stormwater source control” is used to capture rainfall at the source (e.g., on building lots or within road right-of-ways) and return it to natural hydrologic pathways—infiltration and evapotranspiration—or reuse it at the source. Stormwater source control creates hydraulic disconnects between impervious surfaces and watercourses (e.g., streams), thus reducing the volume and rate of surface runoff.

It is currently difficult to assess the cost and benefit tradeoffs of stormwater source controls. Watersheds typically have a management plan developed based on a watershed study that provides a realistic and feasible framework for overall watershed protection that includes combining watershed controls like best management practices and land use management. Because these studies, however, are conducted at a large scale, the effects of individual stormwater management source control measures cannot be effectively evaluated. Without knowing the effects of these measures, it is difficult to strike a balance between watershed protection, economic growth, and quality of life issues.

It would be desirable to have an effective way to analyze the effects of various stormwater source control efforts on a development.

### BRIEF DESCRIPTION OF THE DRAWINGS

FIG. 1 is a display page illustrating a high-level development design in one embodiment.

FIG. 2 is a block diagram illustrating components of the modeling system in one embodiment.

FIGS. 3A-3B illustrate dialog boxes for specifying the water quality simulation options and environmental conditions of the development.

FIG. 4 illustrates a dialog box for specifying the soil types of the development.

FIG. 5 illustrates a dialog box summarizing the composition of the areas of the development.

FIG. 6 illustrates icons representing different land uses that can be part of a development.

FIG. 7 illustrates an example of a detailed design of a new residential development in one embodiment.

FIGS. 8A-8B are dialog boxes illustrating attributes of a development design in one embodiment.

FIG. 9 illustrates a dialog box for input of hydrological parameters of a pervious area.

FIG. 10 illustrates a dialog box with the resulting water balance terms in one embodiment.

FIG. 11 illustrates a dialog box with the parameters and balance terms in one embodiment.

FIG. 12 illustrates a dialog box in which a user inputs intercept and slope values for each flow component.

FIG. 13 is a dialog box that illustrates parameters for dissolved oxygen analysis in one embodiment.

FIGS. 14-17 are dialog boxes that illustrate various parameters in one embodiment.

FIG. 18 illustrates a dialog box for input of hydrological parameters of an impervious area.

FIG. 19 illustrates a dialog box with parameters and balance for impervious sediment in one embodiment.

FIG. 20 illustrates a dialog box with parameters relating to surface runoff water temperature for the impervious block in one embodiment.

FIG. 21A illustrates a dialog box with parameters relating to dissolved oxygen concentration for surface runoff from the impervious block in one embodiment.

FIGS. 21B-24 illustrate dialog boxes with parameters and water balance for nutrients, metals, toxics, and bacteria, respectively, in one embodiment.

FIG. 25 illustrates a dialog box with parameters relating to a stream in one embodiment.

FIG. 26 illustrates a dialog box for water balance for the stream hydraulics in one embodiment.

FIG. 27 illustrates a dialog box showing the parameters and balance in one embodiment.

FIG. 28 illustrates a dialog box for the parameters and water balance relating to temperature in one embodiment.

FIG. 29 is a dialog box that represents DO and BOD parameters and water balance for a stream.

FIG. 30 illustrates a dialog box was parameters and water balance for the eutrophication in one embodiment.

FIGS. 31-33 are dialog boxes that illustrate the parameters and balance instream toxics, metals, and bacteria, respectively, in one embodiment.

FIG. 34 is a dialog box that illustrates the entry of dynamic changes to a development design.

FIGS. 35 and 36 represent a dynamic development animation for a development hierarchical block in one embodiment.

FIG. 37 describes how the dynamically linked model can be used to predict the effects of land use changes on indicator fish species.

FIGS. 38-41 illustrate dialog boxes for parameter value relating to egestion and excretion in one embodiment.

FIG. 42 illustrates a dialog box for fish parameters and balance for a stream in one embodiment.

FIG. 43 illustrates a display page for the setting of watershed protection criteria in one embodiment.

FIG. 44 illustrates peak flow criteria information.

FIG. 45 illustrates flow volume of criteria information.

FIGS. 46A-46C are dialog boxes for the optimization process.

FIG. 47 is a flow diagram of the create design component in one embodiment.

FIG. 48 is a block diagram illustrating the simulate component in one embodiment.

FIG. 49 is a flow diagram illustrating the optimize component in one embodiment.

FIG. 50 is a flow diagram illustrating the calculations performed by a rainfall object.

FIG. 51 is a flow diagram illustrating the calculations performed by an impervious object, such as a roof object.

FIG. 52 is a flow diagram illustrating the calculations performed by the surface routing component of a land area block in one embodiment.

FIG. 53 is a flow diagram illustrating the calculations performed by the stream object in one embodiment.

FIG. 54 is a flow diagram illustrating the processing of the calculations performed by the pervious component in one embodiment.

FIG. 55 is a flow diagram illustrating processing of the calculations performed by the soil water balance component of the pervious object in one embodiment.

### DETAILED DESCRIPTION

A method and system for modeling water flow (e.g., stormwater, point sources, and water withdrawals) of a watershed restoration project is provided. In one embodiment, the modeling system allows a user to create a graphical representation of the different areas of a development site design. The graphical representation shows the water flows between the different areas. The user may also specify the attributes of each area, such as rate of infiltration, runoff coefficient, size, rate of evapotranspiration, and so on. The modeling system can simulate the impact of rainfall on the development design. The rainfall may be specified on a user-defined time step (e.g., hourly) over a certain period (e.g., one month). The simulation determines the inflow of water to each area and determines the outflow of water for each area. The inflow may be from rainfall, runoff from another area, etc.; and the outflow may be from runoff, infiltration, evapotranspiration, groundwater losses, etc. The results of this simulation can be used to evaluate the development design and adjust the design to achieve the desired cost-benefit balance of the watershed protection criteria of choice (e.g., peak water flow). The modeling system may allow a user to specify various watershed protection criteria, which can include peak water flow, flow volume, and water quality, and so on. The modeling system evaluates, based on the simulation, whether any criterion is exceeded. The modeling system can be used to model various types of water flows including stormwater runoff and combined stormwater and sewer flows.

In one embodiment, the modeling system provides objects representing the possible types of areas within each land use that can be part of a development. The land uses may include residential, commercial, industrial, and so on. Each land parcel of the development has an associated land use and is divided into areas that can be pervious and impervious. The impervious areas include roofs, driveways, and roads; and pervious areas include open spaces and yards. The modeling system may provide objects for roofs, driveways, roads, open spaces, and yards. The modeling system also provides objects for sources and sinks of water. The sources of water may include rainfall, a river, reuse, etc., and the sinks of water may include evapotranspiration, soil infiltration, etc. Each object provides a model of its type of area. For example, the object for a roof may model the amount of runoff based on the size of the roof, the amount of rainfall, the type of vegetation which controls evapotranspiration, and soil properties (depth, and infiltration parameters) to estimate runoff volumes. Other elements can include an underdrain beneath the soil layer for removing infiltrated water.

The modeling system allows a user to prepare a graphical representation of the areas of the development showing the dependencies (i.e., water outflows and water inflows) between the areas. Each area of the development may be graphically represented by an icon. Each lot of a residential development may be represented by a roof area, a driveway area, a yard area, a side walk, and a road area and thus be represented by multiple icons. The roof, driveway, side walk, and road areas may have a rainfall inflow and runoff outflow and potential storage in depressions, whereas the yard area also has a rainfall inflow and runoff outflow, and additionally has a soil infiltration, water flow, groundwater, etc., outflow. If the runoff outflow of a lot is directed to an open space, then a dependency between the runoff outflow of the lot and the inflow of the open space is established, which may be represented by a line connecting an icon of the lot and the open space. A dependency indicates that water flows from one area to another area.

The modeling system allows the user to specify attributes of the areas and sources of water of the development. The attributes of an open-space area may include its size, slope, soil type, and so on. The attributes of a rainfall water source may be the hourly rainfall totals over a certain period, such as the three months of a rainy season. The modeling system simulates the water flows by iteratively calculating the outflows and inflows of each area of the development at certain intervals. For example, if the rainfall totals are hourly, then the modeling system may perform the calculations representing one-hour intervals. The modeling system calculates the total water inflow for each area based on the rainfall amounts and the total water outflow of each area based on runoff coefficients, infiltration rates, and so on. The dependencies define the order in which the calculations for each object are performed. In particular, the calculations for an area are not performed until the calculations for the areas that provide it water are first calculated. The modeling system can track and provide reports based on peak water flows and total water flow for each area within the development. The modeling system allows the user to change the attributes and areas of the development to analyze the effects of different land uses on the watershed.

In one embodiment, the modeling system may provide an interface to a geographic information system (“GIS”) to input information relating to the development site to be modeled. The modeling system may allow a user to select the developments, lots, etc. of the GIS whose information is to be used by the modeling system. For example, if a new development is selected, then the number of lots and attributes (e.g., size) of the areas of each lot can be retrieved from the GIS and used to initialize the data of the modeling system. The modeling system allows the user to modify these attributes and specify the inter-area water flows.

In one embodiment, the modeling system provides an optimizer (that includes optimization routines) that identifies a development design that is optimal as indicated by an objective function. After a user defines a development design, the user specifies an objective function that rates the design. The objective function may, for example, define profit for the development and thus rate the design based on amount of profit. The user also defines various constraints of the development design. For example, one constraint may be the minimum and maximum number of lots in a residential development, and another constraint may be the minimum and maximum number of acres of open space. The modeling system selects initial parameters (e.g., 150 lots) within the constraints, performs the simulation with those parameters, and then calculates the objective function. The system then selects new parameters, performs the simulation, and re-calculates the objective function. The modeling system selects the new parameters based on whether the objective function is converging to an optimal solution. One skilled in the art will appreciate that various well-known optimization techniques may be used for guiding the selection of parameters. The system repeats this process until the parameters for the highest rated optimized design is found and all the stormwater requirements for the site or watershed are satisfied.

In one embodiment, the modeling system provides a continuous-simulation model based largely on physical processes that occur within bio-retention facilities, vegetated swales, green roofs, and infiltration devices, as well as effects of site fingerprinting and soil compaction. The modeling system accounts for runoff generation from all categories of land covering including roadways, landscaping, and buildings over a variety of land uses and soil types, for new development and redevelopment.

The modeling system optimizes the balance between economic growth and watershed protection. The modeling system provides least-cost stormwater management solutions that meet watershed protection and quality-of-life objectives. Some of the potential uses of the model are to identify appropriate, site-specific best management practices, and to evaluate the effects of volume-based, peak flow, and water quality controls. The modeling system, developed on an Extend dynamic stimulation platform in one embodiment, is a visually oriented interactive tool that allows a wide range of applications from site design, site analysis and review, and public education.

The modeling system may be also used for sediment analysis to simulate sediment transport, water quality, and stream hydraulics for a site or watershed. The modeling can be used to help control peak stormwater flows while protecting receiving waters from pollutants. The modeling system may also factor in dynamic land use changes. For example, when lots of a multi-lot development are modified, their land use changes over time and are factored into the modeling. In another embodiment, the modeling system can be used to predict the effects of land use on aquatic biota. The modeling system can integrate with a fish bioenergetics model to predict the effects of development on fish.

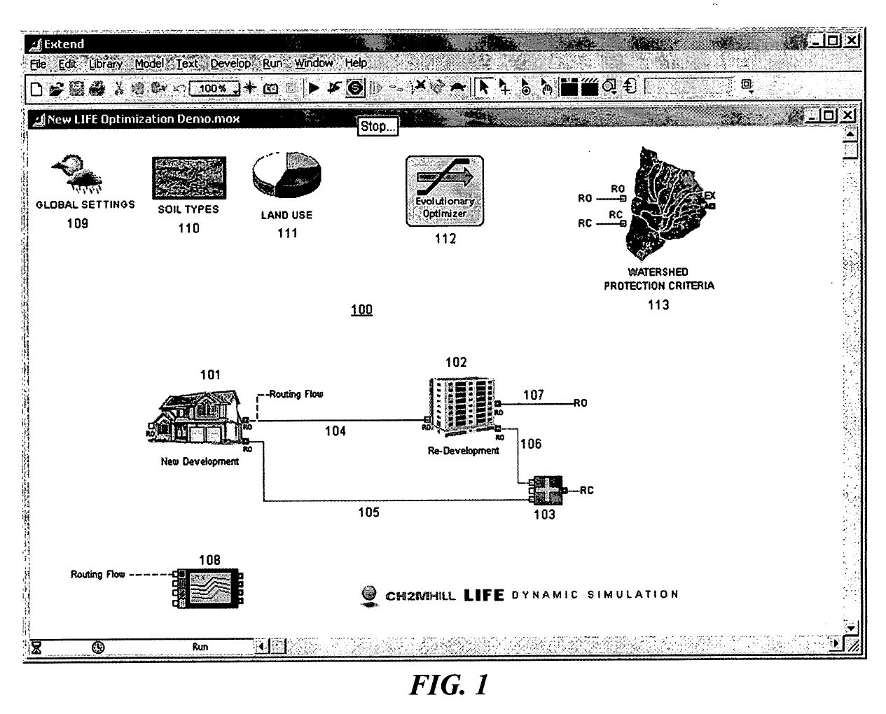

FIG. 1 is a display page illustrating a high-level development design in one embodiment. One skilled in the art will appreciate that the modeling system can be used to model flow of water for any development design with different areas and inter-area flow of water and with or without various best management practices. The development design 100 includes a new development icon 101 and a redevelopment icon 102. The new development icon 101 represents a new residential development that may include many lots and open spaces. The redevelopment icon 102 represents a commercial redevelopment. The lines between the icons represent flow of water and thus dependencies. For example, line 104 between the new development icon 101 and the redevelopment icon 102 represents the runoff flowing from the new development to a downgradient redevelopment area. The aggregation icon 103 represents combining the recharge of the new development represented by line 105 and the recharge of the redevelopment represented by line 106 resulting in the aggregate recharge for the development design. Line 107 represents the total runoff from the redevelopment. Icon 108 represents various graphs of the simulated water flow. Icons 109, 110, and 111 allow a user to specify and view various attributes of the development design. For example, the global settings icon 109 is used to select water quality constituents for simulation and to set the rainfall and other meteorological attributes. The soil types icon 110 is used to specify the types of soil found in the development. The land use icon 111 is used to summarize the various land uses within the development (e.g., total impervious acres for each land use). The evolutionary optimizer icon 112 is used to specify constraints and the objective function for the optimization process. The watershed protection criteria 113 is used to establish various levels for watershed protection such as peak flow, flow volume, or water quality. The user specifies the level or combinations of levels, and the modeling system highlights any exceedances based on the simulation results.

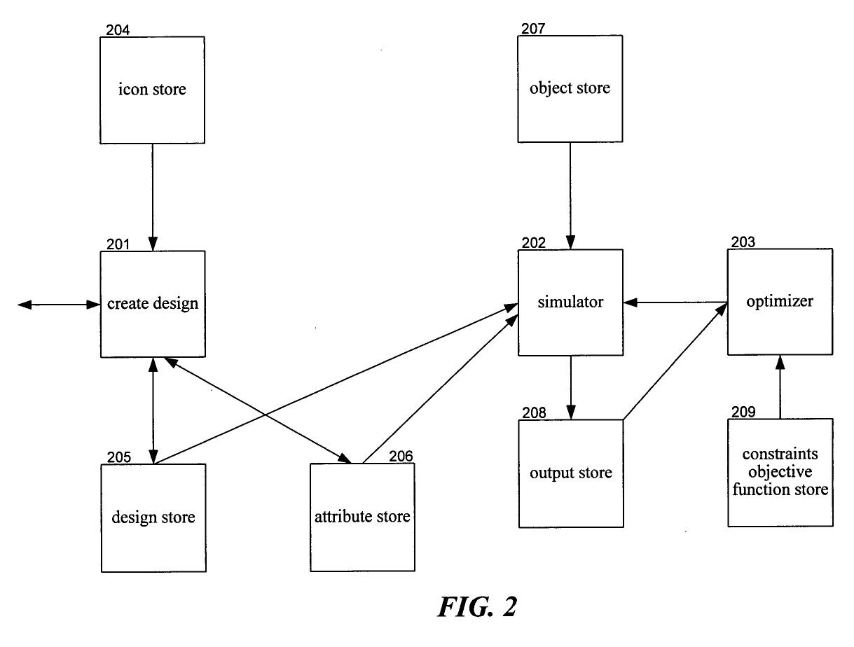

FIG. 2 is a block diagram illustrating components of the modeling system in one embodiment. The modeling system comprises a create design component 201, a simulate component 202, and an optimize component 203. The create design component 201 is used to generate a development design or to store a current design developed using other approaches. The create design component 201 receives user input on the placement of icons representing the development design. The user selects from the icons of the icon store 204. The create design component 201 stores the design in the design store 205 and the user-specified attribute in the attributes store 206. The create design component 201 handles the interaction with the user to place icons, connect icons, and set the values for the various attributes. The create design component 201 may also import areas of the development and their attributes from a GIS. The simulate component 202 simulates the flow of water quantity and quality based on the development design as indicated by the design store 205 and the attribute store 206. The simulator component 202 instantiates an object from object store 207 for each icon represented in the design store 205. In one embodiment, an object is defined for each type of icon. For example, each type of area has an object that is invoked by the simulate component 202 to calculate the outflow of an area including evaporation, transpiration, and infiltration during each iteration of the simulation. The simulate component 202 may invoke other objects to initialize or input values before the simulation. The simulate component 202 invokes the objects representing an area during each iteration of the simulation in an order based on the dependencies. The results of the simulation are stored in output store 208. The output may include a history of the flow or water quality information of each object for each iteration. The optimize component 203 identifies a set of parameters for the development design that best fits an objective function. The objective function and constraints for the optimization are stored in the constraint and objective function store 209. The optimize component 203 sets initial parameters for the simulation within the constraints and then performs the simulation. The optimize component then evaluates the objective function and selects a new set of parameters within the constraints. The optimize component repeats the performing of the simulation and establishing of new parameters repeatedly until the evaluation of the objective function converges to an optimal solution (e.g., maximize profits).

The modeling system may execute on a computer system that includes a central processing unit, memory, input devices (e.g., keyboard and pointing devices), output devices (e.g., display devices), and storage devices (e.g., disk drives). The memory and storage devices are computer-readable media that may contain instructions that implement the modeling system. In addition, the data structures and message structures may be stored or transmitted via a data transmission medium, such as a signal on a communications link. The modeling system may be implemented using various well-known simulator tools. In one embodiment, the modeling system is implemented on the Extend modeling environment, which is described in detail in “The Extend Simulation Environment” by David Krahl, published in the Proceedings of the 2000 Winter Simulation Conference, which is hereby incorporated by reference.

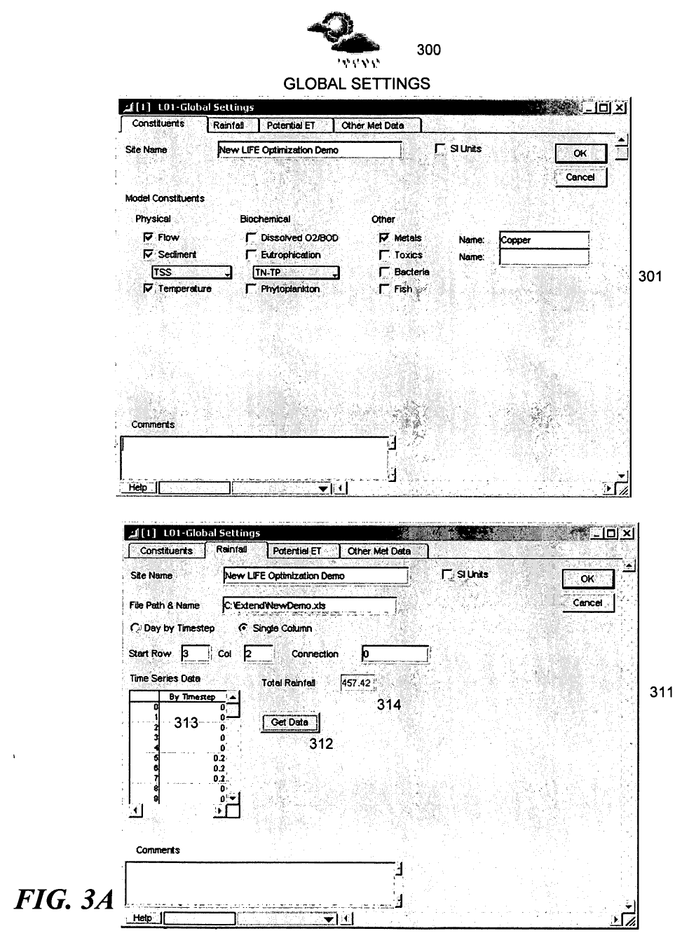

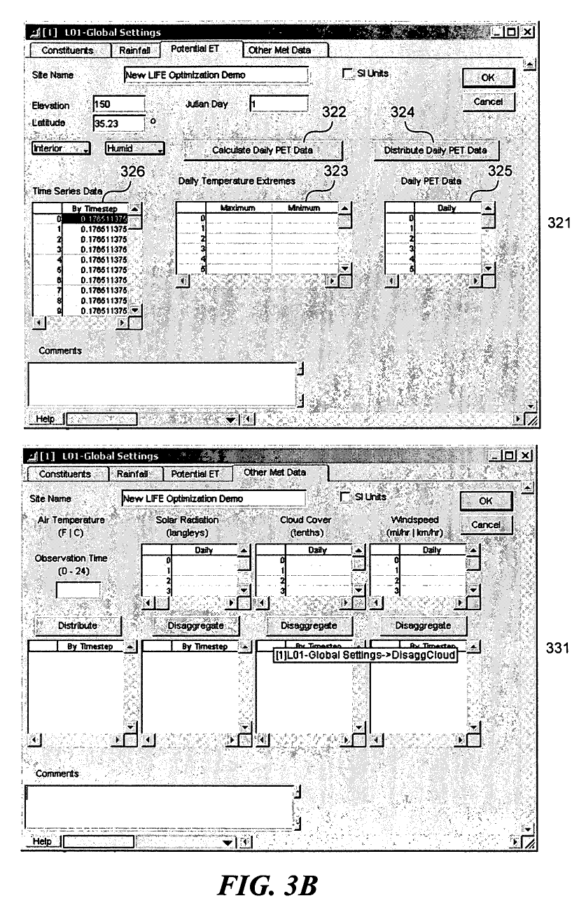

FIGS. 3A and 3B illustrate dialog boxes for specifying the water quality simulation options and environmental conditions of the development. When a user selects icon 300, the modeling system displays dialog boxes 301, 311, 321, and 331. The constituents dialog box 301 is used to specify which of the available water quality constituents will be modeled. The rainfall dialog box 311 is used to specify the rainfall amounts for the development. The rainfall amounts may be imported from a spreadsheet that specifies the rainfall amount per period (e.g., hour). The dialog box is used to specify the location and format of the spreadsheet. The get data button 312 is used to retrieve the rainfall data, which is displayed in field 313 and totaled in field 314. In one embodiment, the rainfall amounts are assumed to be the same throughout the development. One skilled in the art will appreciate that different rainfall amounts could be specified for different parts of the development. For example, a residential development on a dry side of a mountain may have a rainfall amount that is different from a residential development on the other side of the mountain indicating a choice of multiple rainfall stations within a development or watershed. The evapotranspiration dialog box 321 specifies attributes of the potential amount of water that leaves the watershed per certain area because of evaporation or transpiration. The dialog box is used to specify evapotranspiration parameters, elevation, latitude, daily minimum and maximum temperatures, and characteristics of the location such as coastal or humid. Optionally, the ET can be estimated from daily temperatures. The calculate button 322 is used to calculate the daily potential evapotranspiration amounts based on these parameters (e.g., using the Penman-Monteith equation), including the daily minimum and maximum temperatures that may be entered into field 323, with the results appearing in field 325. The distribute button 324 may then be used to create values by simulation timestep and display the amounts in field 326. The meteoroligic data dialog box 331 is used to enter air temperature, solar radiation, cloud cover, and windspeed data, which may be required for various water quality algorithms.

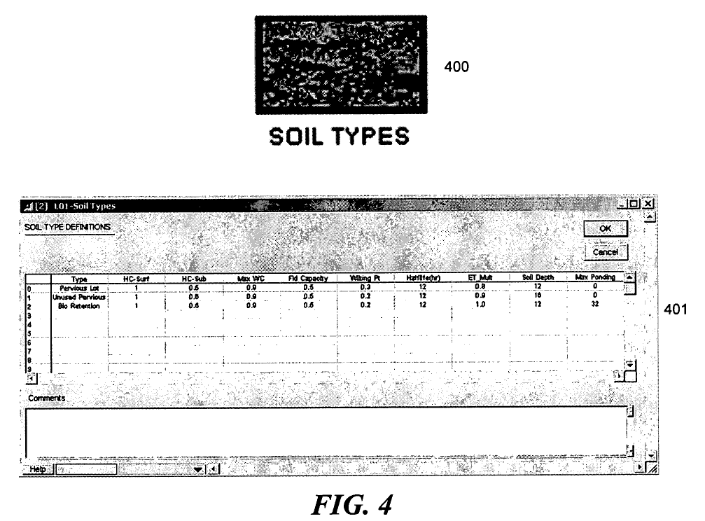

FIG. 4 illustrates a dialog box for specifying the soil types of the development. When the user selects icon 400, the modeling system displays dialog box 401. The soil types dialog box 401 indicates that three types of soil for an example development have been specified: pervious lot, unused pervious, and bioretention. One skilled in the art will appreciate that any number of soil types can be simulated by the modeling system. The attributes of each type of soil include hydraulic capacity of the surface and subsurface, maximum water content, field capacity, wilting point, surface drainage half-life, evapotranspiration multiplier, soil depth, and maximum ponding depth. Each pervious area of the development design is designated as having one of these soil types.

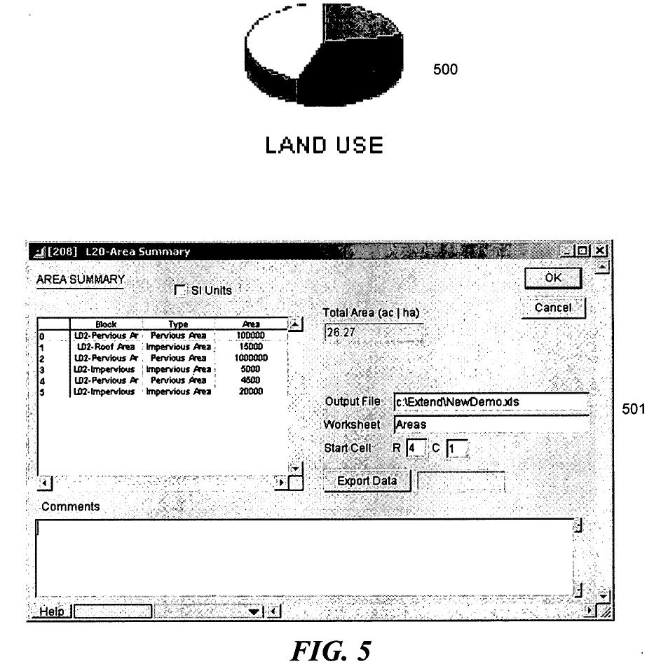

FIG. 5 illustrates a dialog box summarizing the composition of the areas of the development. When a user selects land use icon 500, the modeling system displays dialog box 501. The areas dialog box 501 indicates the pervious and impervious size of each land use within the development. In this example, land use 0 is a pervious area of about 100,000 square feet, land use 1 is an impervious area of 15,000 square feet, and so on, for a total area of 26.27 acres.

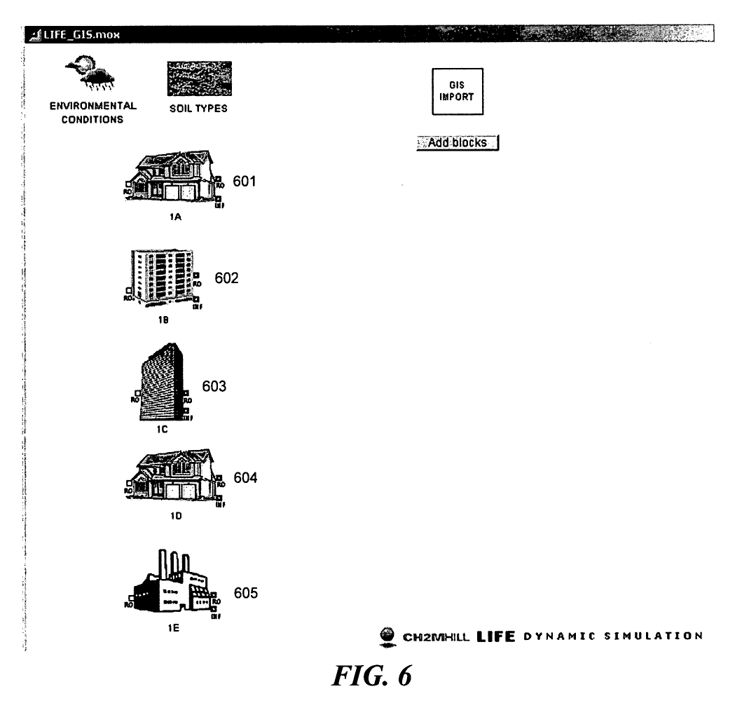

FIG. 6 illustrates icons representing different land uses that can be part of a development. In this example, the icons represent the different land uses imported from a GIS. Icon 601 represents a new residential development, icon 602 represents a commercial redevelopment, icon 603 represents a commercial development, icon 604 represents a residential redevelopment, and icon 605 represents a factory or industrial development. To create a development design, a user selects land use icons and positions them on the display. The user can then specify the dependencies between them. This specifies the high-level development design. To specify the details of each land use, the user selects the land use and is provided with a blank display page area. The user then positions on the display page the areas that comprise the land use. For example, the user may position an icon for a roof, driveway, and yard to represent a lot. Alternatively, the details can be imported from the GIS. The user can then specify the dependencies of the design. To specify a dependency, the user may select an outflow of one icon and connect it to an inflow of another icon. The modeling system then draws a line between the icons. The modeling system provides a hierarchy of land uses and areas within a land use. One skilled in the art would appreciate that a development design may specify many different levels within the hierarchy. For example, a development design may include a new residential development and a commercial redevelopment at its highest level. The next level of the residential development may specify lots, open spaces, and bioretention facilities. The next level of the lots may specify various areas of the lot, such as roof, driveway, road, and yard.

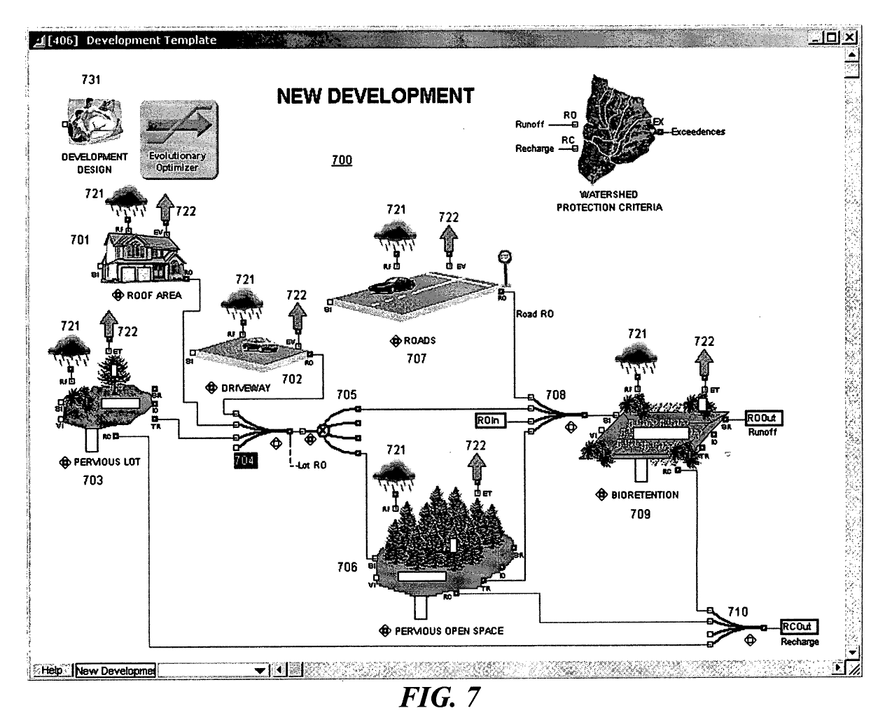

FIG. 7 illustrates an example of a detailed design of a new residential development in one embodiment. This new development 700 corresponds to new development 101 of FIG. 1. The new development is represented by icons 701-710. Roof icon 701, driveway icon 702, yard icon 703, and road icon 707 represent the areas (e.g., on average) of each residential lot. The development design icon 731 is used to specify the attributes of the residential lots. For example, the development design may specify that there are 100 lots with the certain average roof size, driveway size, yard size, and road size contribution. Icons 721 represent the total rainfall for each area. The user can select a rainfall icon 721 to view information about the rainfall for the area. Evapotranspiration icons 722 may be selected by the user to view the evapotranspiration characteristics of an area. Pervious lot icon 723 may be selected by the user to view the recharge rate of an area. The aggregating icons 704, 708, and 710 specify that outflows from various areas are to be aggregated. For example, aggregating icon 710 indicates that the infiltration for areas 703, 706, and 709 are to be aggregated into a total infiltration for the new development. The splitting icon 705 indicates that a flow is to be divided into multiple flows. A splitting flow may have percentages associated with each outflow to indicate the percentage of inflow that is to be provided to that outflow. The open space icon 706 represents a pervious open space of the development. The bioretention icon 709 represents a bioretention facility within the development. One skilled in the art will appreciate that various best management practices can be used for stormwater control such as bioretention, detention basins, two-layer infiltration and so on. The bioretention facility has associated rainfall, evapotranspiration, and infiltration characteristics. The lines connecting the icons represent the various water flows within the development and thus dependencies. For example, the bioretention facility receives runoff from the lot and the open space. Thus, the bioretention facility is dependent on all the other areas within the development. The open space area is, however, only dependent on the roof, driveway, and yard areas of a lot because the runoff from the roads are routed directly to the bioretention facility and not to the open space. These flow dependencies and connections can change from site to site within a study area. Thus, when the modeling system performs the simulation of the water flow for this example, the calculations for the roof, driveway, and yard areas are performed before the calculations for the open space, and the calculations for the open space are performed before the calculations for the bioretention facility. In one embodiment, the modeling system may animate the development design during the simulation. For example, if there is rainfall during an iteration, then the rainfall icons may be switched to show rain. As another example, the color of the lines between the icons may be changed to red when capacities are exceeded.

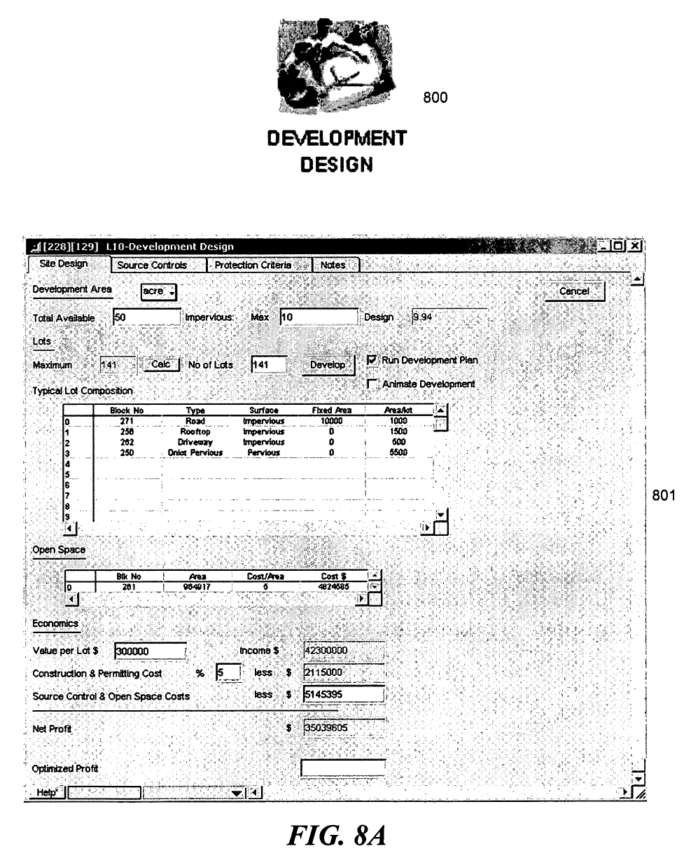

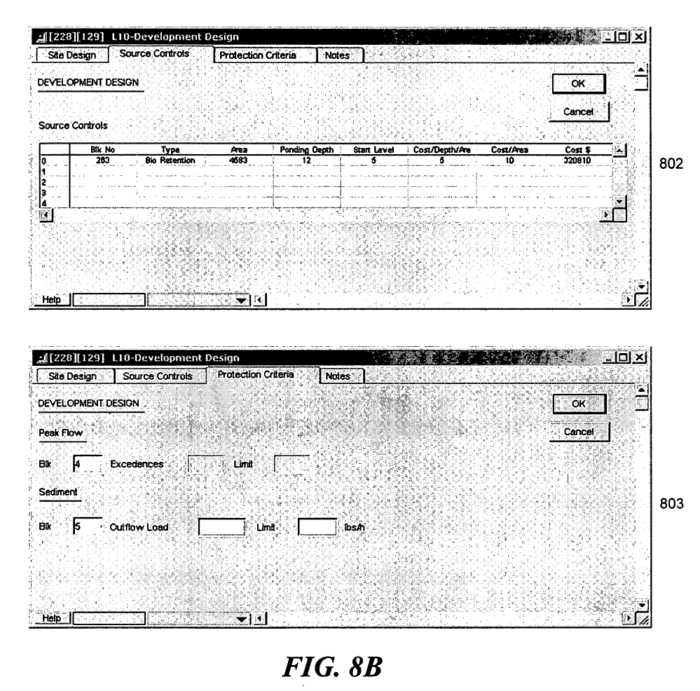

FIGS. 8A-8B are dialog boxes illustrating attributes of a development design in one embodiment. When a user selects icon 800, the modeling system displays the dialog box whose tabs are shown in 801-803. The development design dialog box 801 indicates that the attributes include the number of lots in the development, the size of the development (e.g., in acres), the monetary value of each lot, the construction and permitting costs as a percent of lot value, the total source control and open-space costs, and the typical composition of each lot. The types of source controls and bioretention facilities are shown in 802, and the applicable watershed criteria are referenced in 803. The modeling system calculates the profit, construction and permitting cost per lot, and net profit based on the cost and the design of the development. In this example, each lot is allocated a road area, a roof area, a driveway area, and an on lot pervious (or yard) area. Each area may be assigned a fixed area size plus an area size per lot. For example, the total roads may have a fixed area of 10,000 square feet and each lot adds an additional 1000 square feet to the total road area. The source control facilities may include a bioretention facility and other best management practices. The bioretention facility may be defined with an area, a ponding depth, a cost per depth per area, a cost per area, and a total fixed cost. The open space area may be defined by an area size, a cost per area, and a total fixed cost.

### Hydrology, Sediment and Water Quality

In one embodiment, the modeling system can be used to simulate water quality, stream hydraulics, and sediment transport for a site or watershed. Stormwater management within a watershed is extremely critical as excessive unmanaged flows in the watershed and excessive sediment, nutrient and other pollutant loads generated within the watershed degrade our streams, reservoirs, lakes, and oceans. The simulation can help decision makers make sound decisions for watershed protection, i.e., how best to protect the watershed from high flows, high sediment loads, and other water problems that arise from development in the watershed. The modeling system provides simulation components for pervious areas, impervious areas, and streams and for each of these components, sub-components relating to hydrology, sediment, and water quality.

I. Pervious Component

A. Hydrology Sub-Component

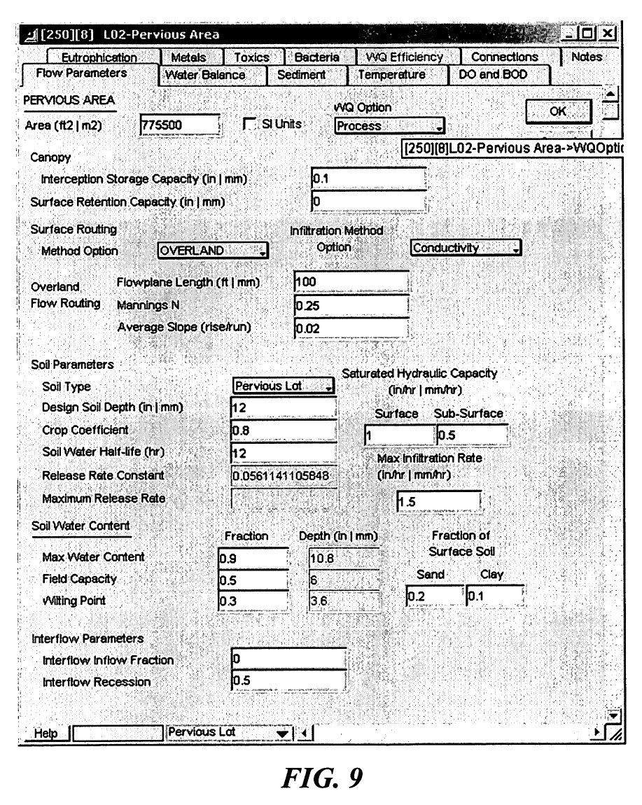

FIG. 9 illustrates a dialog box for input of hydrological parameters of a pervious area. The parameters relate to interception by vegetative cover, surface retention, infiltration, interflow, and overland flow.

1. Interception

In one embodiment, the modeling system handles interception by vegetative cover by a bucket approach, with rainfall and evapotranspiration impacting interception storage directly and overflow reaching the soil surface. The modeling system assumes that surface lateral inflow bypasses interception entirely. The modeling system models interception based on a canopy interception storage capacity parameter. The modeling system defines canopy interception storage capacity by the following equation:
Cᵢ=Cᵢ₋₁+Pᵢ−Eᵢ−Oᵢ
where Cᵢ is interception storage capacity at time i, Cᵢ₋₁ is interception storage capacity at time i-1, Pᵢ is rainfall at time i, Eᵢ is evaporation up to potential at time i, and Oᵢ is overflow at time i. Overflow represents the amount of water that exceeds the interception storage capacity of the vegetative cover. The modeling system may allow the interception storage capacity to vary seasonally.

2. Surface Retention

In the modeling system, surface retention storage represents a water storage capacity within the pervious area as a result of surface roughness and small depressions in the pervious area. The modeling system assumes that surface runoff does not occur until the surface retention capacity has filled.

3. Infiltration

The modeling system handles infiltration for pervious areas as a function of the soil moisture and the hydraulic conductivities of both the surface and subsurface soil layers. In this formulation, the user specifies a maximum infiltration rate, which applies when the soil is at or below field capacity. When the soil moisture rises above field capacity, then the infiltration rate drops linearly to the saturated hydraulic conductivity for the surface soil layer, which is reached when soil moisture equals porosity. The modeling system models infiltration according to the following equation:
I=Iₘₐₓ−Iₘₐₓ−Hₛ)*(θ−f)/(p−f)
where I is infiltration capacity, Iₘₐₓ is maximum infiltration capacity for surface soil, H is surface soil hydraulic conductivity, θ is soil moisture, f is field capacity, and p is porosity.

The modeling system assumes that when the resulting soil moisture is above field capacity, then the excess water is subject to further percolation toward the water table based on a user-specified release rate. This rate is further subject to the limit of the lesser of the saturated conductivities of the surface soil layer and the subsurface layer. The modeling system represents percolation by the following equation:
P=Min [(θ−f)*R, Hₛ, H_{sub}]
where P is percolation, Min is the minimum function, θ is soil moisture, f is field capacity, R is release rate, Hₛ is surface soil hydraulic conductivity, and H_{sub} subsurface soil hydraulic conductivity. The modeling system represents release rate R by the following equation:
R=1−exp (−0.692 Δt/h)
where R is release rate, Δt is hours per time step, and h is surface soil layer drainage half-life.

The modeling system represents the overall water balance for the control depth of soil by the following equation:
ΔSM=Min [I, S]−P−E*C
where ΔSM is change in soil moisture, I is infiltration capacity, S is surface water supply (retention storage+rainfall+lateral inflow), P is percolation, E is potential evapotranspiration remaining after interception evapotranspiration, and C is crop coefficient for dominant vegetation (which may vary seasonally).

The modeling system may alternatively use the Mein-Larson implementation of the Green-Ampt method for infiltration. When using this alternative, the modeling system may represent the maximum infiltration rate by the following equation:
f_{inf}=Kₑ(1+(Ψ_{wf}*Δθᵥ)/F_{inf})
where f_{inf} is infiltration rate for current time step, Kₑ is effective hydraulic conductivity, Ψ_{wf} is wetting front matric potential, Δθᵥ is change in volumetric moisture content across the wetting front, and F_{inf} is cumulative infiltration. If the rainfall intensity is less than this maximum, then the modeling system adds the full rainfall amount to the cumulative infiltration. Otherwise, the modeling system uses the maximum rate, and the excess rainfall remains on the surface to be routed after being subject to surface retention storage.

4. Interflow

When the soil moisture is above field capacity, it becomes available for lateral movement from one area to another, which is referred to as interflow. In one embodiment, a fraction of such soil moisture is available, and a recession constant defines how much of the available interflow leaves the pervious area per time step. The modeling system represents interflow by the following equation:
II=k*(SM−FC)
where II is interflow inflow, k is fraction of excess soil moisture subject to lateral flow, SM is soil moisture, and FC is field capacity. The modeling system subtracts interflow inflow from the soil moisture and tracks it as a separate interflow storage. The modeling system represents the outflow from this storage by the following equation:
Q=S*(1.0−RC)
where Q is interflow outflow, S is interflow storage, and RC is a recession constant.

5. Overland Flow

The modeling system can handle overland flow in various ways with the same equations used for pervious and impervious areas. In one embodiment, the modeling system may assume that for small sites with short overland flow times relative to the model time step, surface runoff may not need to be routed. That is, the modeling system assumes that all water that reaches the overland flow plane results in direct runoff. In another embodiment, the modeling system may apply a runoff coefficient. The modeling system assumes that the fraction of water on the surface represented by the runoff coefficient runs off in the interval, with the rest remaining until the next time step, after being subject to evaporation. The modeling system represents the surface runoff by the following equation:
Q=k*S
where Q is surface runoff, k is a runoff coefficient, and S is surface storage. In an alternate embodiment, the modeling system assumes that runoff can be routed across the Horton overland plane using the version of the Chezy-Manning equation from the HSPF model (Bicknell et al, 2000). The runoff amount is a function of length, slope, and roughness, with different factors for the rising and falling limbs of the hydrograph. The modeling system represents surface depression/retention storage factoring in rising and falling limbs by the following equations:

$$\begin{matrix}Q = 3346.5 * {s}^{0.5} / ( n * L ) * {( 1.6 * S )}^{1.67} & ( falling limb ) \\ Q = 3346.5 * {s}^{0.5} / ( n * L ) * {( S * ( 1 + 0.6 {( S / {S}_{e} )}^{3} ) )}^{1.67} & ( rising limb )\end{matrix}$$

where Q is surface runoff, s is slope, n is Manning's roughness coefficient, L is overland flow length, S is mean surface storage over interval, and Sₑ is equilibrium surface storage given surface inflow rate. The modeling system represents equilibrium surface storage by the following equation:
Sₑ=0.004184*(n*L*s^{-0.5})^{0.6}*I^{0.6}
where Sₑ is equilibrium surface storage, L is overland flow length, n is Manning's roughness coefficient, s is slope, I is surface inflow rate.

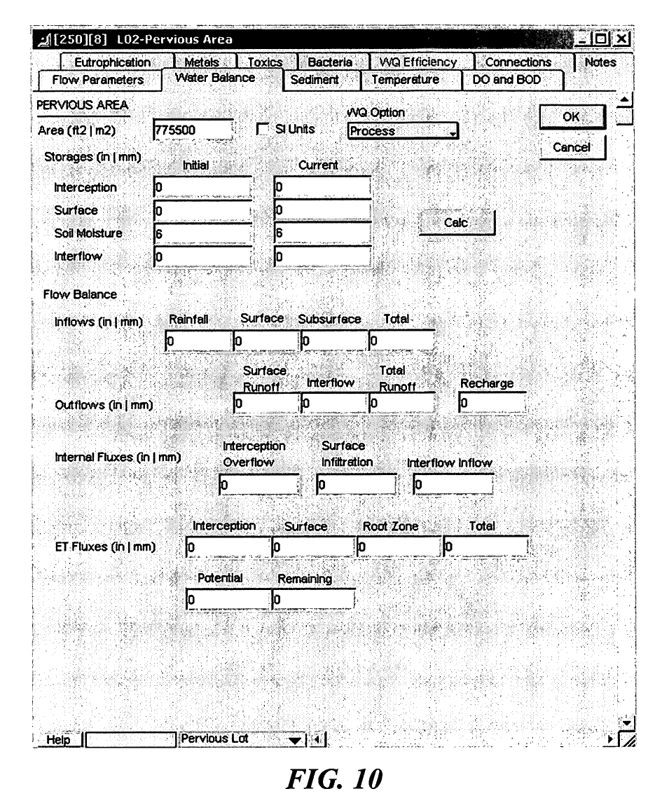

FIG. 10 illustrates a dialog box with the resulting water balance terms in one embodiment.

B. Sediment Sub-Component

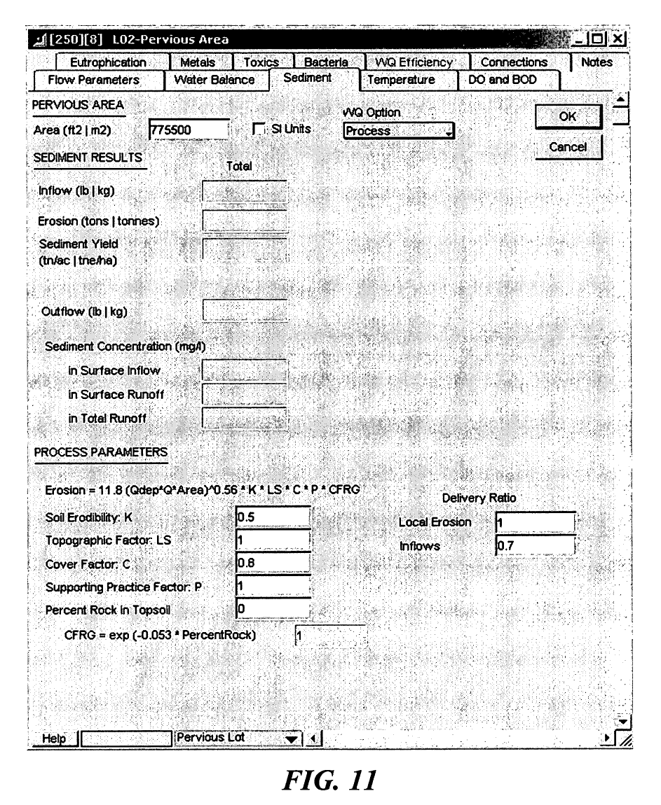

In one embodiment, the modeling system calculates the sediment erosion from pervious soil using the Revised Universal Soil Loss Equation, which is used in the SWAT model (Neitsch et al., 2000). FIG. 11 illustrates a dialog box with the parameters and balance terms in one embodiment. The modeling system represents sediment generated by the following equation:
Xₜ=11.8*(Q*qₚₖ*A)^{0.56}*K*(LS)*C*P*CFRG
where Xₜ is sediment generated on time step t, Q is surface runoff volume, qₚₖ is peak runoff rate, A is area of the pervious block, K is USLE soil erodibility factor, LS is USLE topographic factor, C is USLE cover and management factor, P is USLE support practice factor, and CFRG is coarse fragment factor.

After calculating the sediment erosion, the modeling system calculates the transport of the sediment to the edge of the stream. The modeling system represents the transport by the following equation:
Yₜ=Xₜ*D
where Yₜ is sediment load to edge of stream, Xₜ is sediment generated on time step t, and D is delivery ratio. The modeling system divides the load by the flow and passes the resulting concentration downstream. In one embodiment, the modeling system may divide the load and concentration into sand, silt, and clay portions by user-defined constant fractions.

C. Water Quality Sub-Component

1. Water Temperature

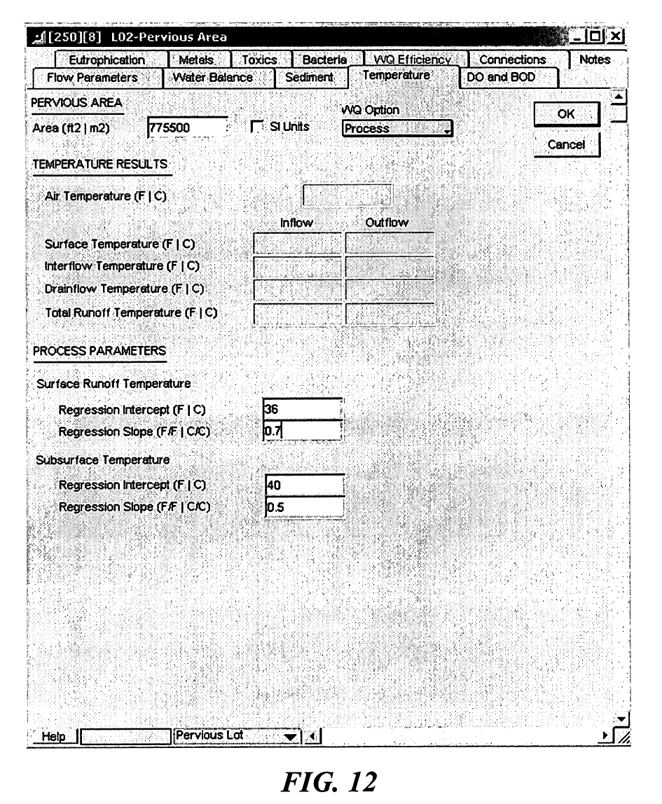

The modeling system computes the temperatures of surface runoff and interflow as regressions on air temperature. FIG. 12 illustrates a dialog box in which a user inputs intercept and slope values for each flow component.

2. Dissolved Oxygen

The modeling system may assume that the dissolved oxygen concentration of surface runoff to be at saturation for the temperature of surface runoff. The modeling system represents saturation of dissolved oxygen by the following equation:
SAT=(14.652+T_{w}*(−0.41022+T_{w}*(0.007991−0.7777E−4*T_{w})))*Fₚ
where SAT is saturation dissolved oxygen concentration, T_{w} is water temperature, and Fₚ is correction factor on air pressure due to elevation. The modeling system represents the correction factor on air pressure by the following equation:
Fₚ=((288.0−0.001981*E)/288.0)^{5.256}
where Fₚ is correction factor on air pressure due to elevation and E is elevation.

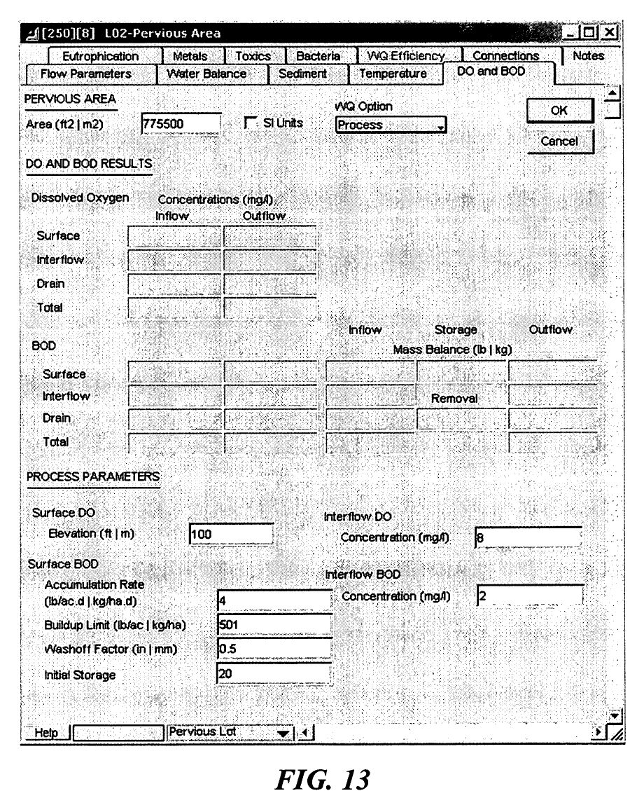

The modeling system assigns a subsurface concentration to interflow. The modeling system may allow this concentration to vary seasonally. FIG. 13 is a dialog box that illustrates parameters for dissolved oxygen analysis in one embodiment.

3. General Water Quality Loadings

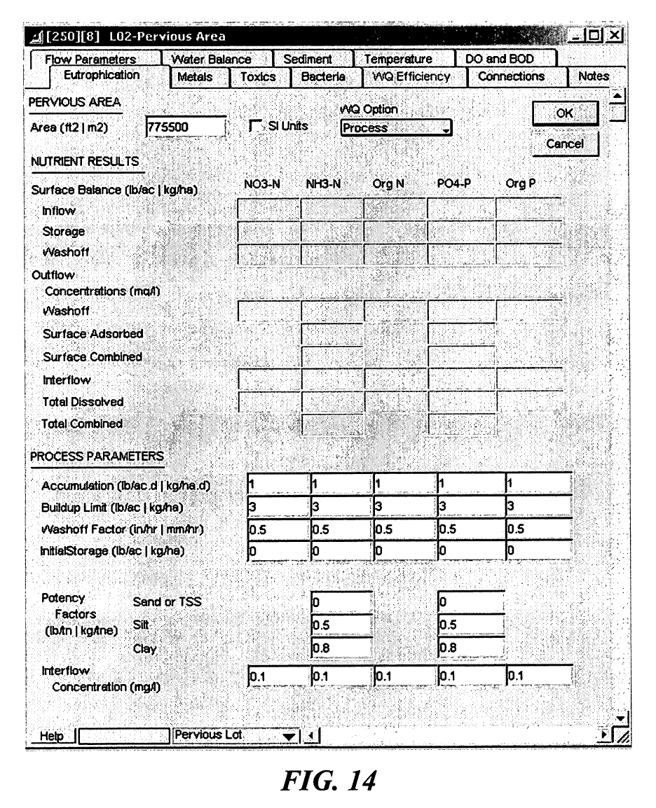

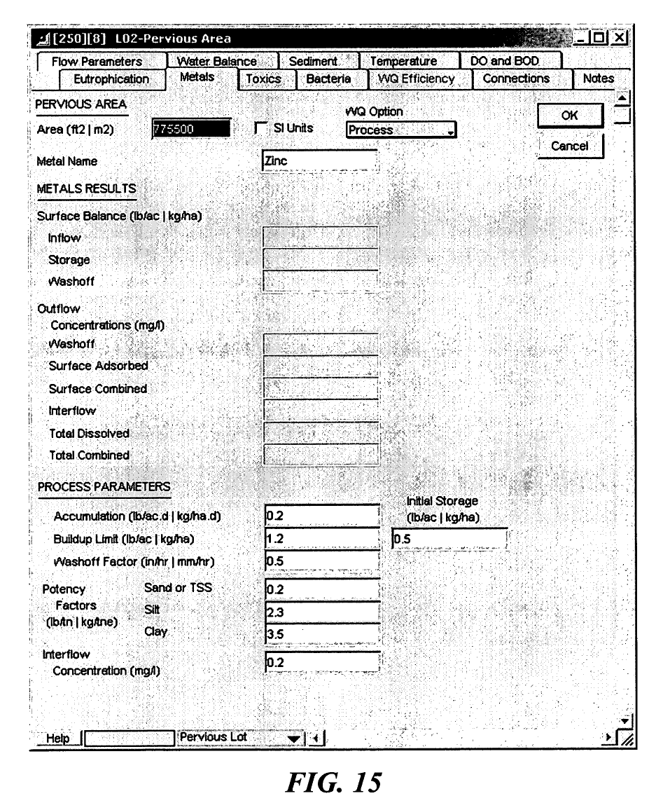

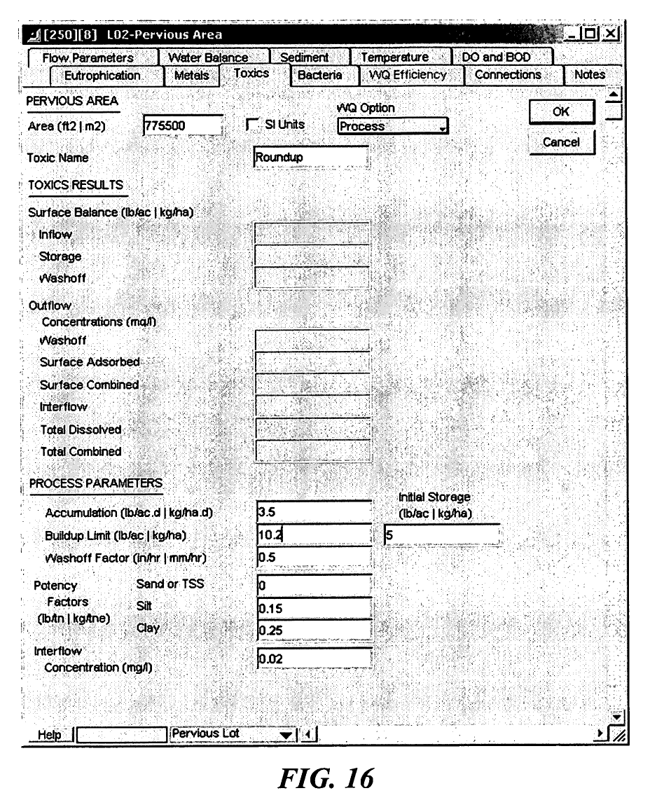

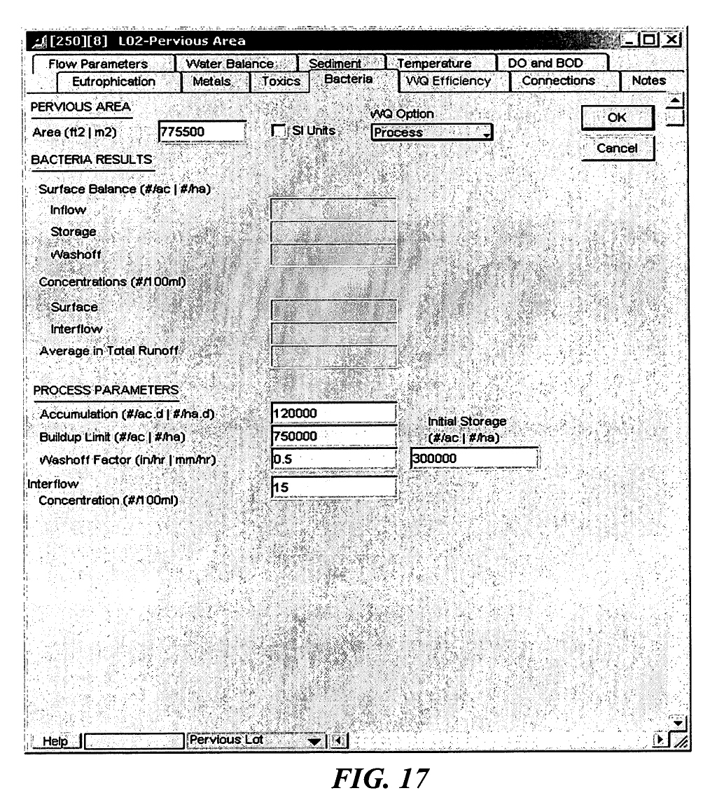

The modeling system provides generalized methods of washoff and build-up of various water quality constituents. FIGS. 14-17 are dialog boxes that illustrate various parameters in one embodiment. These generalized methods, which are described in equations below and have been used and tested in the literature such as in the HSPF model, can be used for BOD (Biochemical Oxygen Demand) in the DO-BOD section as shown in FIG. 13; nitrate, ammonia, phosphate, and organic nitrogen and phosphorus in the Eutrophication section, shown below in FIG. 14; and metals, toxic chemicals, and bacteria, shown in FIGS. 15, 16, and 17, respectively. The modeling system may, as an alternative to the Eutrophication section, allow for generation of total nitrogen and total phosphorus instead of the detailed loadings by species. The modeling system may assume no loadings for phytoplankton by pervious blocks. The modeling system represents the buildup and wash off of water quality constituents by the following equations:
Sᵢ=Sᵢ₋₁*(1−Rᵢ)+Aᵢ
where Sᵢ is storage of constituent at end of interval, Sᵢ₋₁ is storage of constituent at beginning of interval, Rᵢ is removal rate, and Aᵢ is accumulation rate (kg/interval).
W=S*(1−e^{-Qs/F})
where W is washoff of constituent, S is storage of constituent, Qs is surface runoff rate, and F is washoff factor.

The modeling system assigns potency factors to the sediment loadings for water quality constituents that are commonly adsorbed to sediment. These constituents may include ammonia, phosphate, metals, and toxics. The modeling system may use the same or different potency factors for sand, silt, and clay fractions. The modeling system represents the wash load of water quality constituents by the following equation:
W=S*P
where W is washload of constituent, S is sediment delivered to edge of stream, and P is potency factor. The modeling system may also assign concentrations to interflow for any or all of the water quality constituents. The modeling system may allow the buildup rates and limits, the potency factors, and the interflow concentrations to vary seasonally.
II. Impervious Component

A. Hydrology Sub-Component

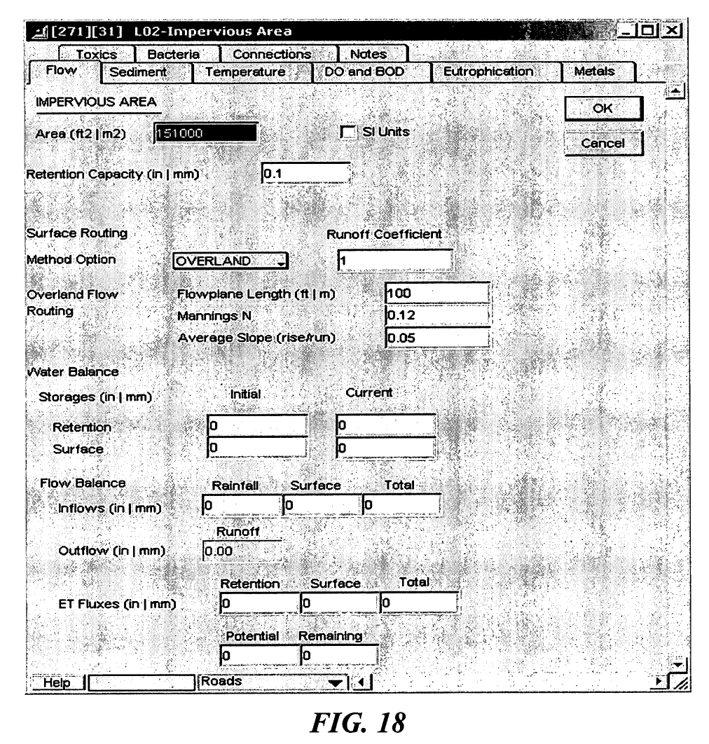

The modeling system uses hydrology algorithms for impervious areas that are a subset of the methods used for pervious areas. The modeling system uses surface retention, surface runoff, and surface evaporation for impervious areas, but may not use interception, infiltration, interflow, and percolation for impervious areas. FIG. 18 illustrates a dialog box for input of hydrological parameters of an impervious area, along with the resulting water balance.

B. Sediment Sub-Component

The modeling system uses sediment algorithms for impervious areas that may differ significantly from those for pervious areas. (See, Pitt, R. Stormwater Quality Management.) The modeling system uses algorithms similar to the buildup and washoff algorithms used for general water quality loadings as described above. The modeling system represents the buildup of sediment for impervious areas by the following equation:
Pᵢ=Pᵢ+(P*A−Pᵢ)(1−e^{-kj})
where Pᵢ is solid accumulated up to t days, Pᵢ is initial solid storage, P is maximum solid build-up, A is impervious area, k is build up factor, and j is rain duration. The modeling system represents the washoff of sediment for impervious areas by the following equation:
W=AᵥW₀(1−e^{-k}^{₂}^{ri})
where W is impervious sediment washoff, Aᵥ is availability factor, W₀ is initial pollutant load, k₂ is washoff rate, r is rainfall intensity, and j is rain duration. The modeling system represents the availability factor by the following equations:
Aᵥ=0.057+0.04r^{1.1} if r<18 mm/hr
Aᵥ=1.0 if r≧18 mm/hr
where Aᵥ is availability factor and r is rainfall intensity.

An alternative method for the washoff is based on surface runoff rather than rainfall, using an equation of a similar form:
W=W₀(1−e^{kqj})
where W is impervious sediment washoff, W₀ is initial pollutant load, k is washoff rate, q is surface runoff depth, and j is timestep duration.

The modeling system represents the quantity of sediment transferred with runoff by the following equation:
ΔP=Pᵢ−Pᵢ
where delta P is the quantity of sediment transferred with runoff, Pᵢ is initial solid storage, and Pᵢ is solid accumulated up to t days.

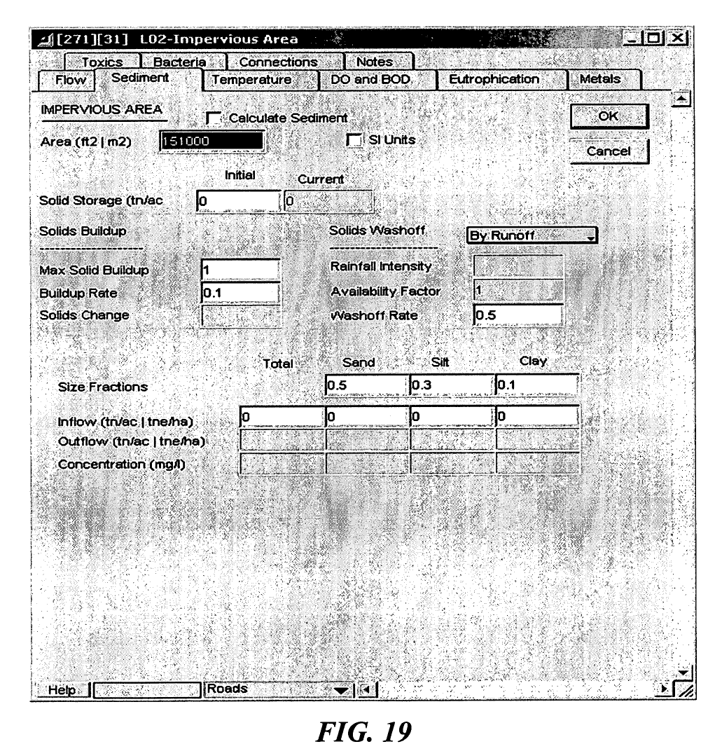

FIG. 19 illustrates a dialog box with parameters and balance for impervious sediment in one embodiment. As for the pervious areas, the modeling system may optionally divide the sediment washoff into sand, silt, and clay portions according to constant user-defined fractions.

C. Water Quality Sub-Component

1. Water Temperature

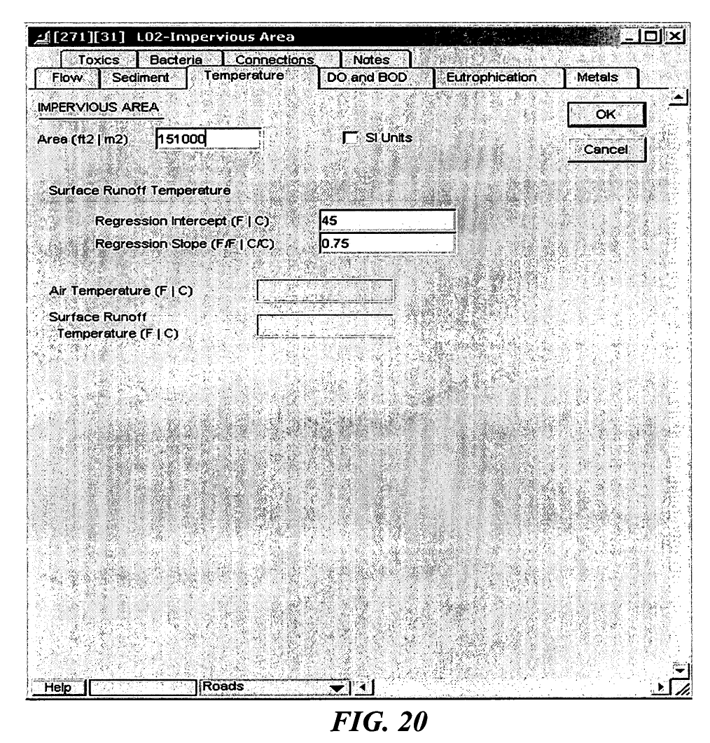

FIG. 20 illustrates a dialog box with parameters relating to surface runoff water temperature for the impervious block in one embodiment. The modeling system may use the same equations for both pervious and impervious areas.

2. Dissolved Oxygen

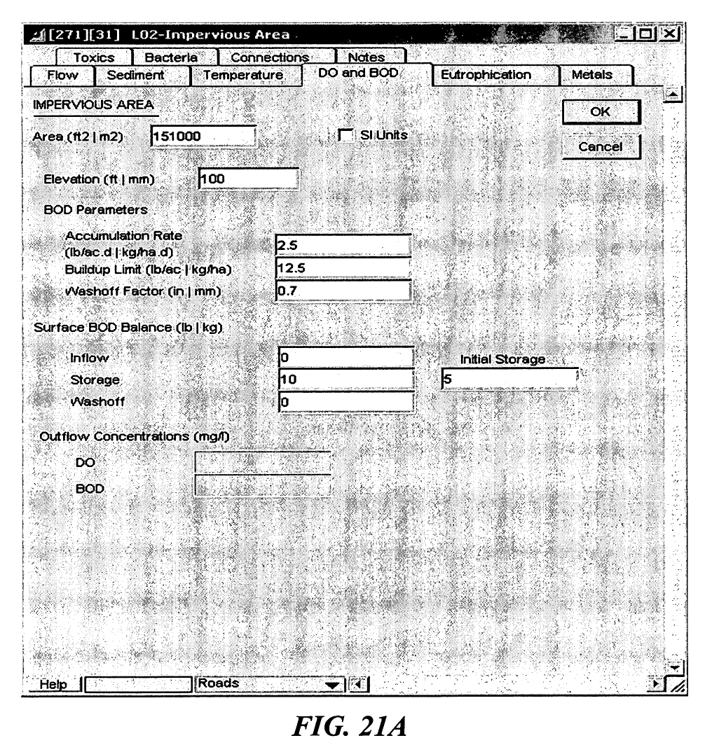

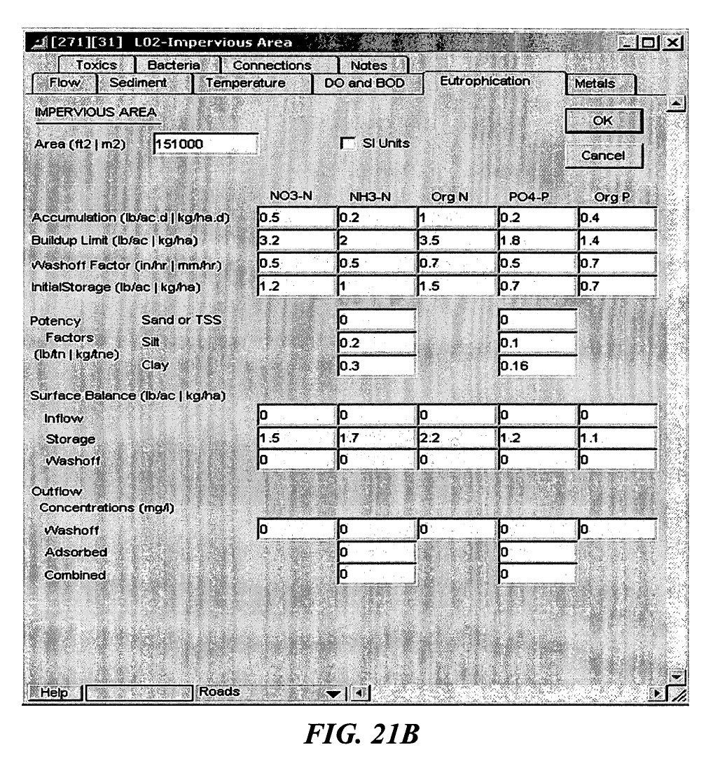

FIG. 21A illustrates a dialog box with parameters relating to dissolved oxygen concentration for surface runoff from the impervious block in one embodiment. The modeling systems may use the same equations for dissolved oxygen concentration for both pervious and impervious areas. The modeling system may assume that there are no interflow concentrations.

3. General Water Quality Loadings

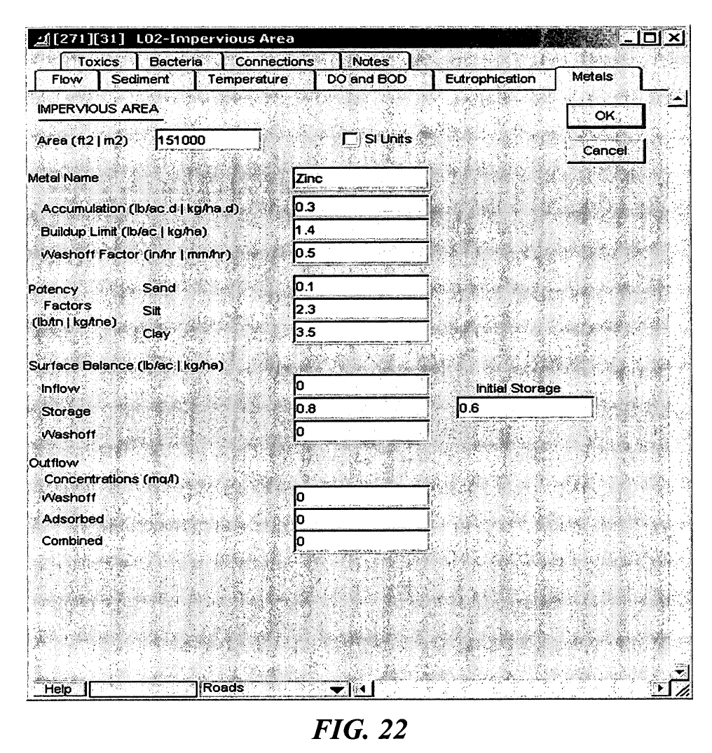

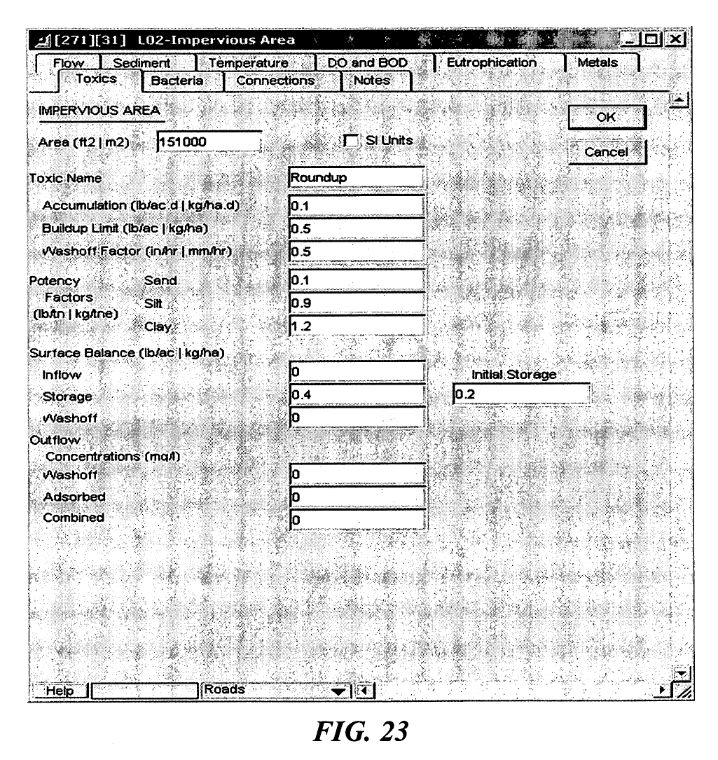

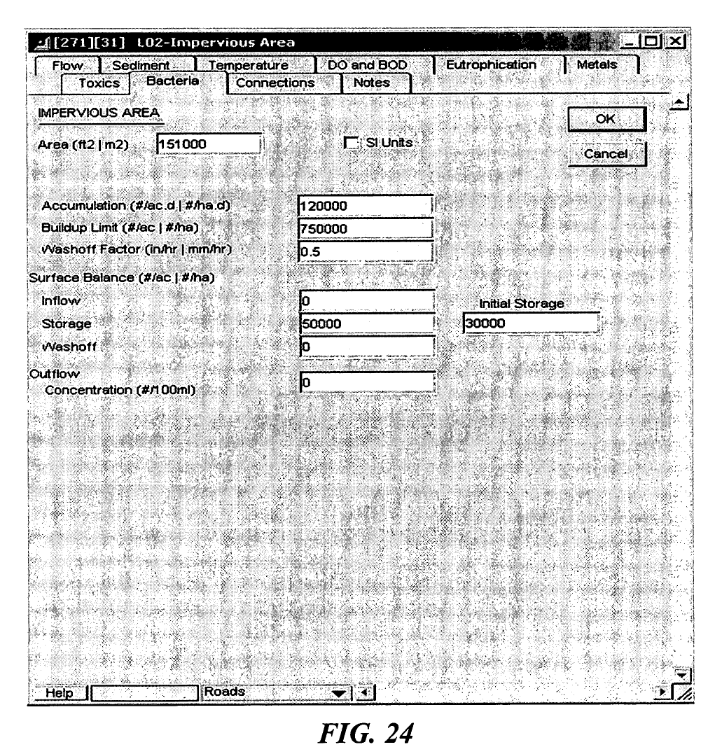

FIGS. 21B-24 illustrate dialog boxes with parameters and water balance for nutrients, metals, toxics, and bacteria, respectively, in one embodiment. The modeling system may use similar method to determine the water quality constituents for the impervious areas as for the pervious areas. The modeling system may assume that there are no interflow concentrations.

III. Stream Component

The stream component of the modeling system is used to simulate stream channels, rivers, canals, ponds or any other open systems that convey runoff or water from the watershed to a point further downstream.

A. Hydrology Sub-Component

The modeling system in one embodiment provides two options for routing flow in stream objects. For ponds and other impoundments, the modeling system may assume that surface storage can be retained in ponded conditions, with any excess above a maximum storage running off immediately. The modeling system represents the outflow volume in such a case by the following equation:
Q=Max(0.0, Sᵢ+I+R−E−C)
where Q is outflow volume, Sᵢ is initial storage in stream reach, I is inflow volume, R is rainfall volume, E is volume of evaporation, and C is impoundment capacity at outfall invert. Alternatively, the modeling system may assume a more general channel routing model that is patterned after the one used in the SWAT model. In the SWAT model, the flow can be routed using a simple kinematic wave method with Manning's equation for open-channel flow providing the outflow rates. The modeling system allows the user to specify the geometry of the channel to represent storage.

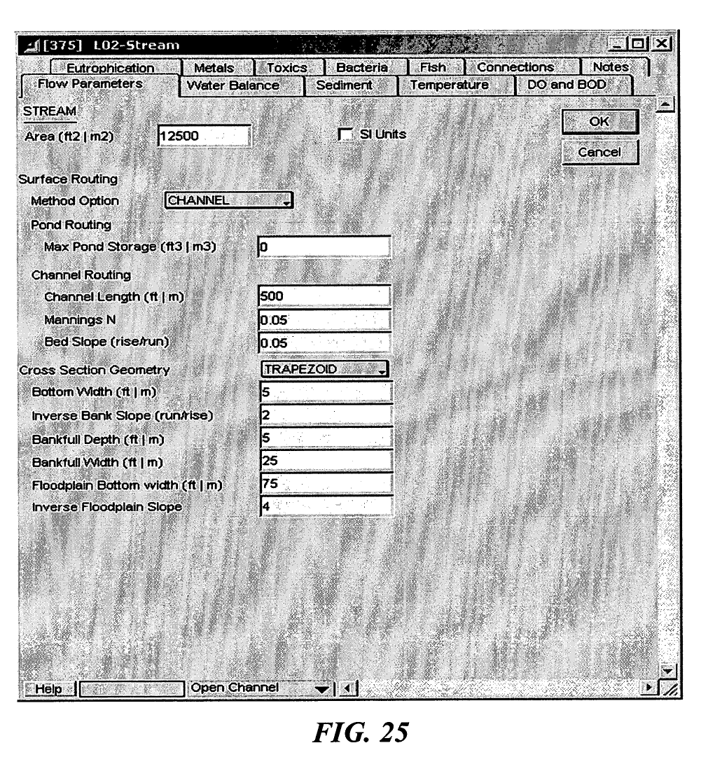

The modeling system may assume that a channel is trapezoidal in shape with the user specifying the bottom width, bank height, and inverse bank slope. These parameters may also allow a triangular (bottom width=0) or rectangular (inverse bank slope=0) channel to be specified. The modeling system may alternatively use a parabolic equation to allow U-shaped channels. The floodplain consists of an additional trapezoid added above the bank. FIG. 25 illustrates a dialog box with parameters relating to a stream in one embodiment. To compute flow, the modeling system first calculates the cross-sectional area using the following equation:
A=(Sᵢ+I+R−E)/L
where A is cross-sectional area, Sᵢ is initial storage in stream reach, I is inflow volume, R is rainfall volume, E is volume of evaporation, and L is length of stream reach. The modeling system then calculates the depth and wetted perimeter based on the assumed cross section. If the storage is at or below the bankfull storage, then the modeling system represents the depth and wetted perimeter by the following equations:

$$D = {( A / {z}_{b} + {( 0.5 {W}_{bc} / {z}_{b} )}^{2} )}^{0.5} - 0.5 {W}_{bc} / {z}_{b}$$

$$P = {W}_{bc} + 2 * D * {( 1 + {z}_{b}^{2} )}^{0.5}$$

where D is depth, A is cross-sectional area, z_{b} is inverse bank slope, W_{bc} is bottom width of channel, and P is wetted perimeter. Conversely, if the storage is above bankfull, then the modeling system calculates the depth and wetted perimeter to account for the floodplain shape parameters as well which are represented by the following equations:

$$D = {D}_{b} + {( ( A - {A}_{b} ) / {z}_{f} + {( 0.5 {W}_{bf} / {z}_{f} )}^{2} )}^{0.5} - 0.5 {W}_{bf} / {z}_{f}$$

$$P = {P}_{b} + {W}_{bf} - {W}_{bc} + 2 * ( D - {D}_{b} ) * {( 1 + {z}_{f}^{2} )}^{0.5}$$

where D_{b} is bankfull depth, A is cross-sectional area, A_{b} is bankfull cross-sectional area, z_{f} is inverse floodplain slope, W_{bf} is floodplain bottom width, P is wetted perimeter, W_{bc} is bottom width of channel, D is depth, and P_{b} is bankfull wetted perimeter. The modeling system represents the hydraulic radius Rₕ by the following equation:
Rₕ=A/P
where Rₕ is the hydraulic radius, A is cross-sectional area, and P is wetted perimeter. The modeling system then calculates the flow at the end of the time step using Manning's equation as represented by the following equation:
q_{f}=1/n*A*Rₕ^{0.667}*S^{0.5}
where q_{f} is instantaneous flow rate at the end of the time step, n is Manning's N value, A is cross-sectional area, Rₕ is the hydraulic radius, and S is longitudinal bed slope. The modeling system calculates the volume of outflow during the time step using the variable storage routing algorithm of the SWAT model. This algorithm first estimates the travel time through the reach using the following equation:
T=L*A/q_{f}
where T is travel time, L is length of stream reach, A is cross-sectional area, and q_{f} is instantaneous flow rate at the end of the time step. The modeling system then calculates a storage coefficient by the following equation:
Cₛ=(2*Δt)/(2*T+Δt)
where Cₛ is storage coefficient, T is travel time, and Δt is time step of the run. The modeling system then calculates the outflow volume by the following equation:
Q=Cₛ*(Sᵢ+I +R−E)
where Q is the outflow volume, Cₛ is storage coefficient, Sᵢ is initial storage in stream reach, I is inflow volume, R is rainfall volume, and E is volume of evaporation.

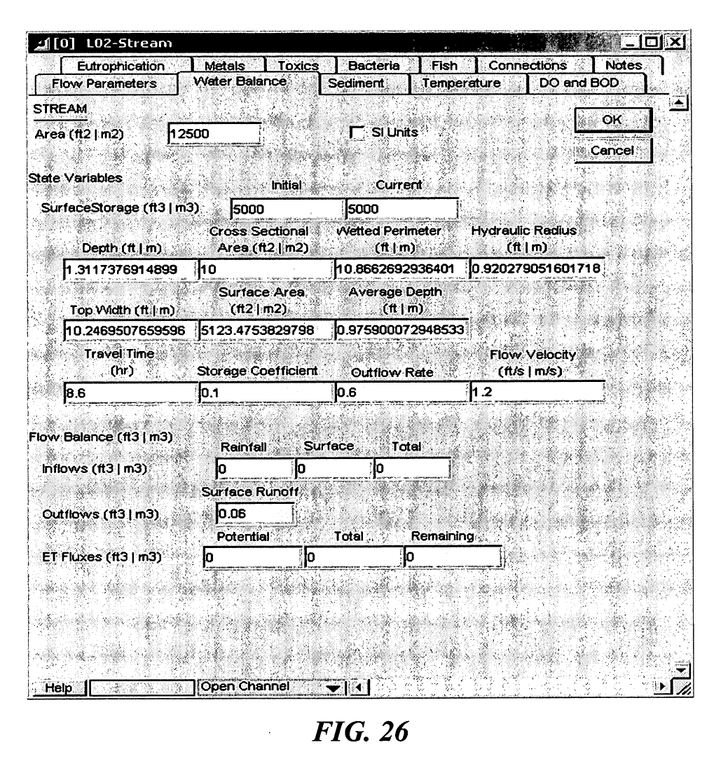

FIG. 26 illustrates a dialog box for water balance for the stream hydraulics in one embodiment.

B. Sediment Sub-Component

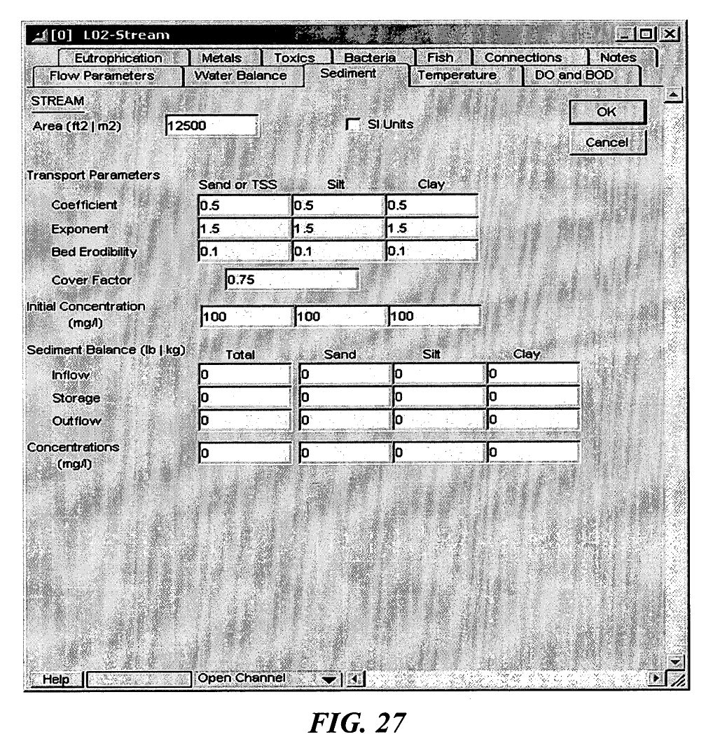

The modeling system simulates instream sediment transport using equations developed and used in the SWAT model by Neitsch et al. (2000). The modeling system calculates the transport capacity as a simple power function of stream velocity as represented by the following equation:
Cₘₐₓ=Kₛv^{Es}
where Cₘₐₓ is maximum sediment concentration, Kₛ is user-defined sediment transport coefficient, v is stream velocity, and Eₛ is user-defined sediment transport exponent. If the existing concentration Cₛ is greater than Cₘₐₓ, then the modeling system calculates the deposition as the excess by the following equation:
D=1000(Cₛ−Cₘₐₓ)*V
where D is deposition, Cₛ is sediment concentration, Cₘₐₓ is maximum sediment concentration, and V is volume of water in stream reach. Conversely, if the sediment concentration is less than the transport capacity, then the modeling system calculates the scour from the bed using the following equation:
S=(Cₘₐₓ−Cₛ)*V*K*CF
where S is scour, Cₘₐₓ is maximum sediment concentration, Cₛ is sediment concentration, V is volume of water in stream reach, K is bed erodibility factor, and CF is bed cover factor. FIG. 27 illustrates a dialog box showing the parameters and balance in one embodiment.

C. Water Quality Sub-Component

1. Water Temperature

The modeling system provides two different algorithms for calculating instream water temperature, as well as the capability to accept an input timeseries of water temperatures. The first algorithm is a function of air temperature as represented by the following equation:
T_{w}=5.0+0.75*Tₐ
where T_{w} is water temperature and Tₐ is air temperature. This is similar to the surface runoff temperature equation used by the pervious and impervious components, but uses the daily average temperature to dampen the variation relative to the diurnal air temperature cycle. This temperature may be modified by a smoothing factor according to the following equation:
Tₛ=Tᵢ+k(Tᵣ−Tᵢ)
where Tₛ is the computed smoothed water temperature, Tᵢ is the temperature at the beginning of the timestep, k is the smoothing factor, Tᵣ is the intermediate temperature computed by regression in the previous equation. A further modification may occur due to a difference in temperature between the water already in the channel or pond and the current inflow of water. The effect is proportional to the fraction of the total volume of water that is current inflow. The equation is:
T_{f}=k(Tᵢ−Tₛ)*(Qᵢₗ(Qᵢ+Sᵢ))
where T_{f} is the final computed water temperature, k is the inflow factor, Tₛ is the (optionally smoothed) temperature after the previous two equations, Qᵢ is the inflow, and Sᵢ is the storage of water at the beginning of the timestep.

The second algorithm is a more complex energy balance approach used by HSPF, which allows the model to represent the effects of differing inflow temperatures on the stream. With this algorithm, the modeling system assumes that the heat exchange between the water and the atmosphere drives the temperature and is represented by the following equation:
Qₜₒₜ=Qₛₒₗ+Q_{iw}+Q_{con}+Q_{prec}−Qₑᵥₐₚ
where Qₜₒₜ is total heat exchange, Qₛₒₗ is input of solar radiation, Q_{iw} is net longwave radiation, Q_{con} is heat exchange due to conduction and convection, Q_{prec} is heat input due to precipitation, and Qₑᵥₐₚ is heat loss due to evaporation. The modeling system calculates these terms by the following equations:
Qₛₒₗ=0.97*Fₛ*Rₛ
where 0.97 is assumption of 3% reflection, Qₛₒₗ is input of solar radiation Fₛ is shading factor for stream reach, and Rₛ is incoming solar radiation (kcal/m2), and
Q_{iw}=−0.97σ(T_{w}⁴−K_{iw}*F_{c}*(Tₐ⁶))
where Q_{iw} is net longwave radiation, σ is Stefan-Boltzmann constant, T_{w} is water temperature, K_{iw} is atmospheric longwave radiation coefficient, F_{c} is cloud factor, and Tₐ is air temperature, and
F_{c}=1.0+(0.0017*C**2)
where F_{c} is cloud factor and C is cloud cover, and
Q_{com}=Fₚ*K_{c}*W*(T_{w}−Tₐ)
where Q_{con} is heat exchange due to conduction and convection, Fₚ is correction factor on air pressure due to elevation, K_{c} is conduction-convection heat transport coefficient, W is wind movement, T_{w} is daily average water temperature, and Tₐ is daily average air temperature and
Fₚ=((288.0−0.001981*E)/288.0)\hat{ }5.256
where Fₚ is correction factor on air pressure due to elevation and E is elevation (m), and
Q_{prec}=P*Tₐ*ρ*Hₛ
where Q_{prec} is heat input due to precipitation, P is precipitation, Tₐ is daily average air temperature, p is density of water, and Hₛ is specific heat of water, and
Qₑᵥₐₚ=E*p*H_{L}
where Qₑᵥₐₚ is heat loss due to evaporation, E is evaporation loss in depth terms, ρ is density of water, and H_{L} is latent heat of vaporization, and
H_{L}=597.3−0.57T_{w}
where H_{L} is latent heat of vaporization and T_{w} is daily average water temperature.

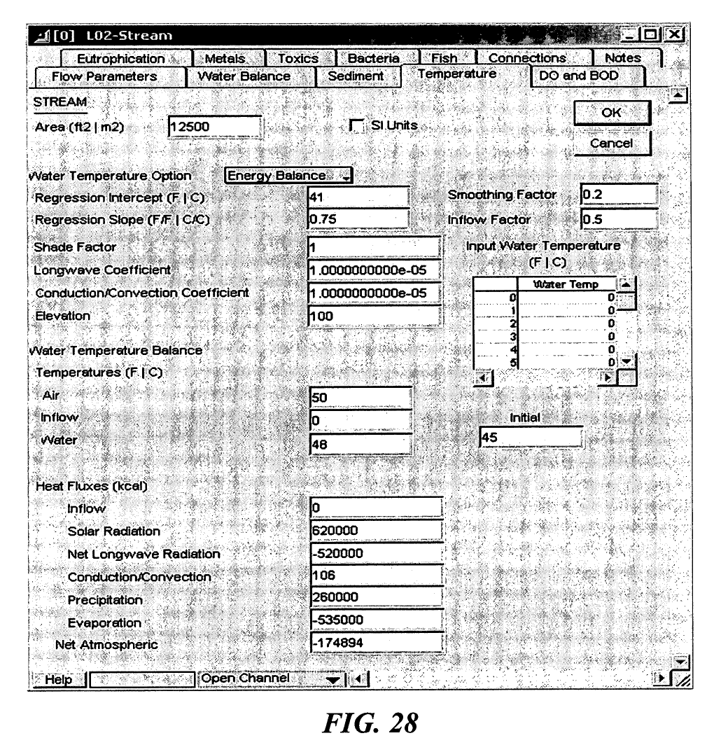

FIG. 28 illustrates a dialog box for the parameters and water balance relating to temperature in one embodiment.

2. Dissolved Oxygen and Biological Oxygen Demand

The modeling system models the Dissolved Oxygen and Biochemical Oxygen Demand (DO and BOD respectively) using the Streeter-Phelps algorithm. When a full eutrophication method is not used, the modeling system assumes that Nitrogenous Biochemical Oxygen Demand (NBOD) is negligible compared to Carbonaceous Biochemical Oxygen Demand (CBOD), or at least well correlated so that they can be lumped together. The modeling system models the BOD decay using temperature-adjusted first-order decay. Also, a Sediment Oxygen Demand (SOD) term will consume further DO, and BOD will settle out at a user-specified fall velocity. The modeling system represents the change in dissolved oxygen storage by the following equations:
ΔDO=I−O+R−D−SOD
where ΔDO is change in dissolved oxygen storage, I is inflow of dissolved oxygen, O is outflow of dissolved oxygen, R is reaeration, D is CBOD decay loss, and SOD is sediment oxygen demand. The modeling system represents change in CBOD by the following equation:
ΔCBOD=I−O+S−D
where ΔCBOD is change in CBOD, I is inflow of CBOD, O is outflow of CBOD, S is sinking of macroscopic organic matter, and D is BOD decay. The modeling system represents sinking of macroscopic organic matter by the following equation:
S=1000C*(Kₛ/d)*V
where S is sinking of macroscopic organic matter, C is concentration of BOD, Kₛ is settling rate, d is depth, and V is volume of water. The modeling system represents BOD decay by the following equation:
D=C*K_{d}*θ_{d}^{(T}^{_{w}}⁻²⁰)
where D is BOD decay, K_{d} is BOD decay rate, θ_{d} is BOD decay temperature correction factor, and T_{w} is water temperature.

The modeling system uses reaeration described by the Covar algorithm for free-flowing streams and the O'Connor wind-driven algorithm for impoundments. The modeling system represents reaeration using the Covar algorithm for free-flowing streams by the following equation:
R=(kᵣ*v^{K}^{ᵥ}*d^{K}^{_{d}}*θ^{(T}^{_{w}}⁻²⁰))*(SAT−DO)
where R is reaeration, kᵣ is reaeration coefficient, v is stream velocity, Kᵥ is velocity exponent, d is stream depth, K_{d} is depth exponent, θ is temperature correction coefficient, T_{w} is water temperature, SAT is saturation DO concentration, and DO is starting DO concentration.

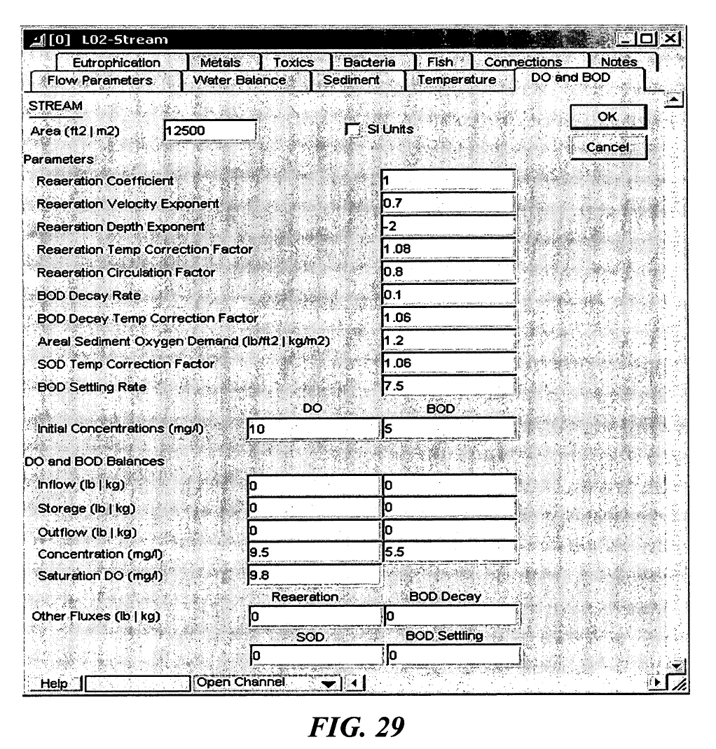

The modeling system represents reaeration using the O'Connor algorithm for wind-driven by the following equation:
R=(0.01*F_{circ}*[W*(−0.46+0.136*W)]/d)*(SAT−DO)
where R is reaeration, F_{circ} is circulation factor, W is windspeed, d is depth, SAT is saturation DO concentration, and DO is starting DO concentration. The modeling system calculates saturation of dissolved oxygen as described above for pervious areas using the following equation:
SAT=(14.652+T_{w}*(−0.41022+T*(0.007991−0.7777E−4*T_{w})))*Fₚ
where SAT is saturation dissolved oxygen concentration, T_{w} is water temperature, and Fₚ is correction factor on air pressure due to elevation. The modeling system represents the correction factor on air pressure due to elevation by the following equation:
Fₚ=((288.0−0.001981*E)/288.0)\hat{ }5.256
where Fₚ is correction factor on air pressure due to elevation and E is elevation. FIG. 29 is a dialog box that represents DO and BOD parameters and water balance for a stream.

3. Eutrophication

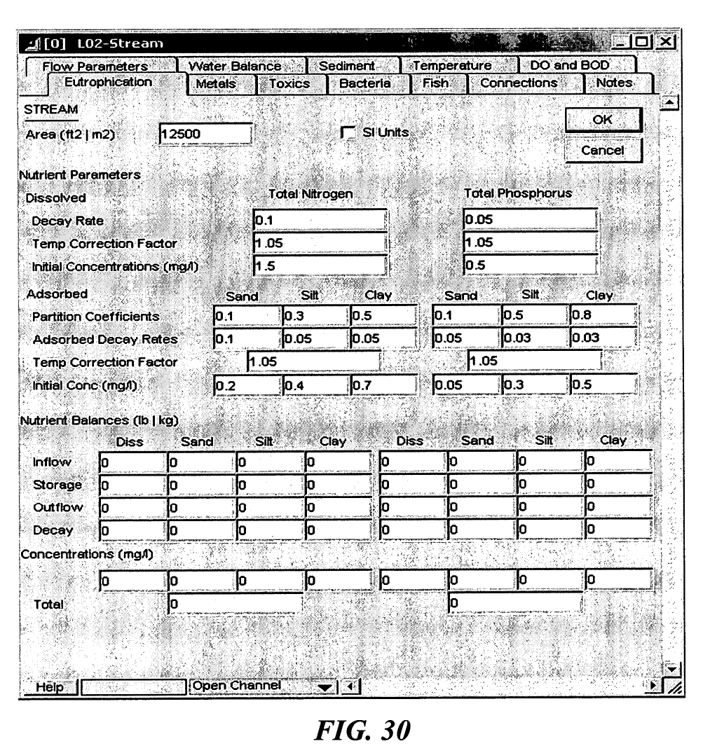

The modeling system models nitrogen and phosphorus using different algorithms. Total nitrogen and total phosphorous may be advected, with a temperature-corrected first order decay rate to represent the assimilative capacity of the stream. Also, partition coefficients may be established so that each may be partially advected in adsorbed form, and separate decay rates for adsorbed quantities may be given. The modeling system assumes that adsorption and desorption reach equilibrium within the timestep, so that transfer rates are not needed. The modeling system represents the nitrogen by the following equation:
D=N*K_{N}*θ_{N}^{(T}^{_{w−20)}}
where D is total nitrogen decay, N is total nitrogen concentration, K_{N} is nitrogen decay rate, θ_{N} is nitrogen decay temperature correction factor, and T_{w} is water temperature. The modeling system may use identical equations for phosphorous decay and for nitrogen and phosphorus adsorbed forms. FIG. 30 illustrates a dialog box for the parameters and water balance for the eutrophication in one embodiment.

The modeling system may also use a more detailed representation of biochemical transformations, including nitrification, denitrification, mineralization, and phytoplankton growth, respiration and death. This more detailed representation may require the separate loading of nitrate, ammonia, orthophosphate, and organic nitrogen and phosphorus from the pervious and impervious blocks rather than using simple total nitrogen and total phosphorous loadings.

4. Instream Metals/Toxics/Bacteria

As for the pervious and impervious blocks, the modeling system uses similar algorithms to model the transport and fate of metals, toxics, and bacteria. The modeling system accounts for the adsorption/desorption of toxics and metals to sediments using partitioning coefficients that specify how much pollutant is in the dissolved phase or attached to sediment, so as to specify the amount absorbed to sediment versus the amount in solution form. None is used for bacteria. The modeling system also uses a temperature-corrected first-order decay/death for toxics and bacteria. No decay rate is used for metals.

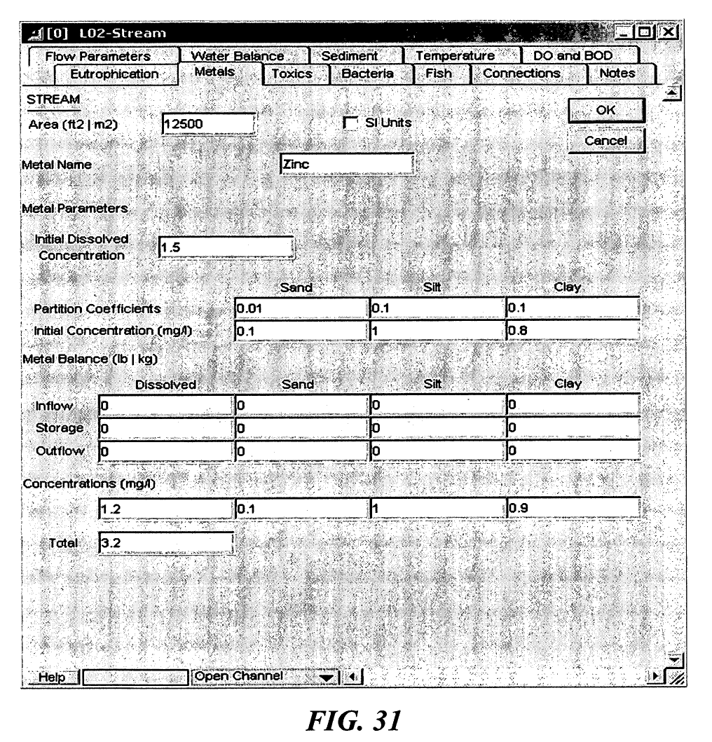

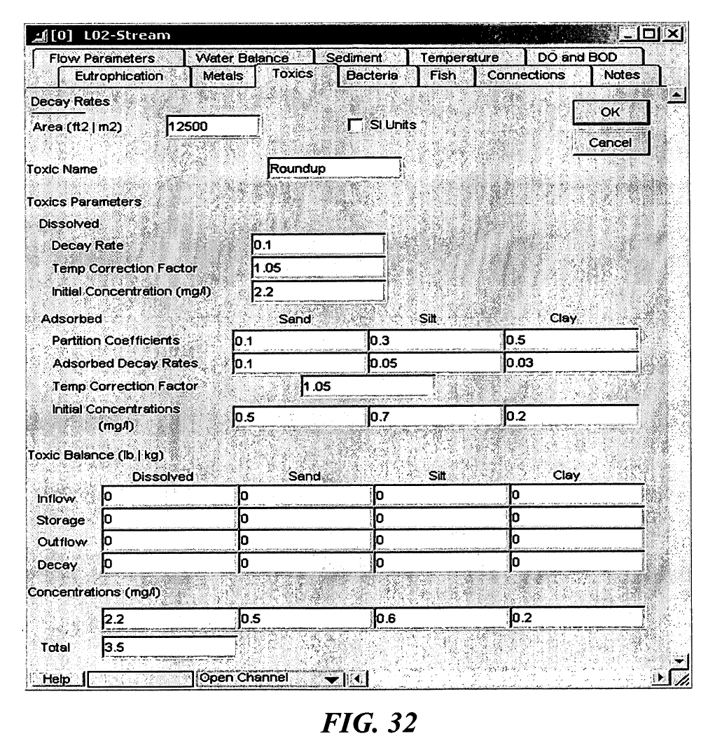

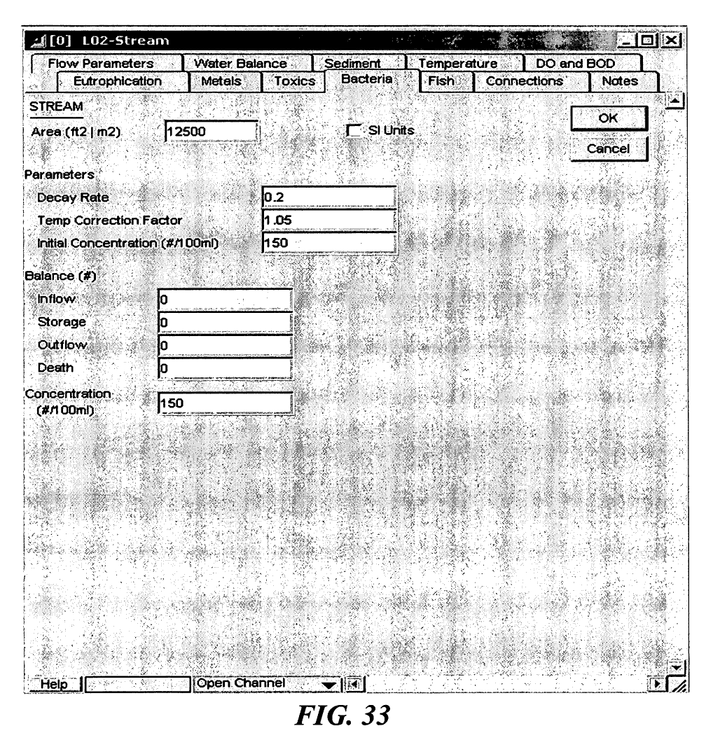

The modeling system uses equations that are the same as for the simple eutrophication equations. FIGS. 31-33 are dialog boxes that illustrate the parameters and mass balance for instream metals, toxics, and bacteria, respectively, in one embodiment.

### Dynamic Simulation

Land use changes within a watershed alter the watershed's water flow and water quality. If static land use is assumed when developing plans for watershed protection based in whole or in part on a watershed model, i.e., the land use does not change during the period of time covered by the watershed model, the model calibration for the watershed can be poor, resulting in watershed management plans that are not based on realistic land use patterns. By taking into account dynamic land use when developing plans for watershed protection based in whole or in part on a watershed model, i.e., the land use changes during the period of time covered by the watershed model, the model calibration for the watershed will be improved, resulting in watershed management plans that are based on more realistic land use patterns. One skilled in the art will appreciate that there are many other potential uses for a modeling system that can simulate dynamic land use changes within a watershed. For example, stormwater management agencies could use such a modeling system to evaluate the impact of dynamic land use changes on their current and proposed stormwater controls, thereby helping these agencies decide appropriate times and places for implementing stormwater controls.

In one embodiment, the modeling system enables simulation of dynamic land use changes within a watershed by allowing a user to input a time series of land use changes that occur within a site or watershed. The modeling system reads this time series and provides results for flow, sediment, and water quality that reflect dynamic land use changes rather than static land use.

The modeling system may be based on a series of dynamic simulation objects that represent the functional representation where one can input the time series of land use changes. The use of the development components allows the user to analyze the results of changing land use and respective water quantity and quality during the simulation. The user can specify land use changes that occur in a specified area in a tabular format such as how much land is being developed daily, monthly, and so on. The resulting changes in land disturbance result in changing water quantity and quality that can be simulated.

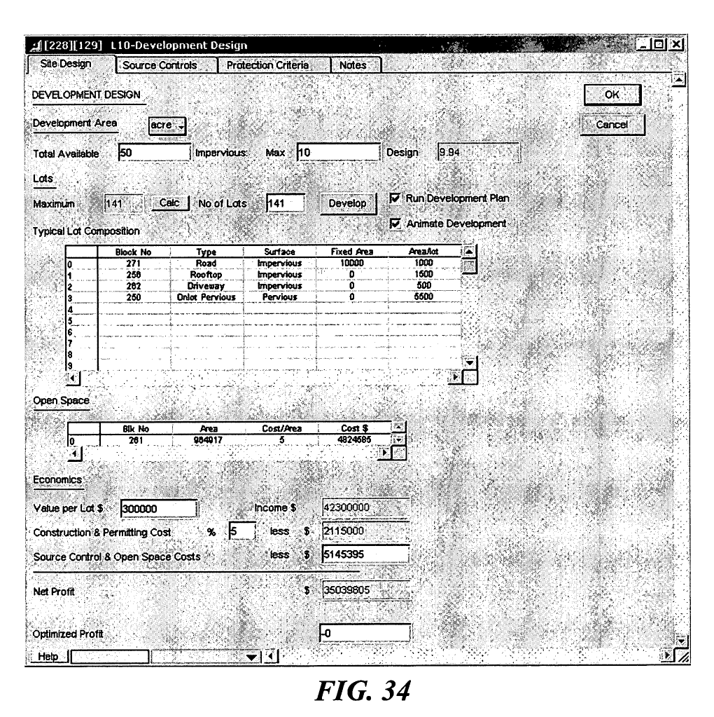

The modeling system allows a time series of lots to be applied to a development design. An input connector receives the number of lots in a particular development at a given time. The development design component is used to apply the appropriate surface areas to each object in a development by referencing a typical lot composition and applying a number of lots. FIG. 34 is a dialog box that illustrates the entry of dynamic changes to a development design.

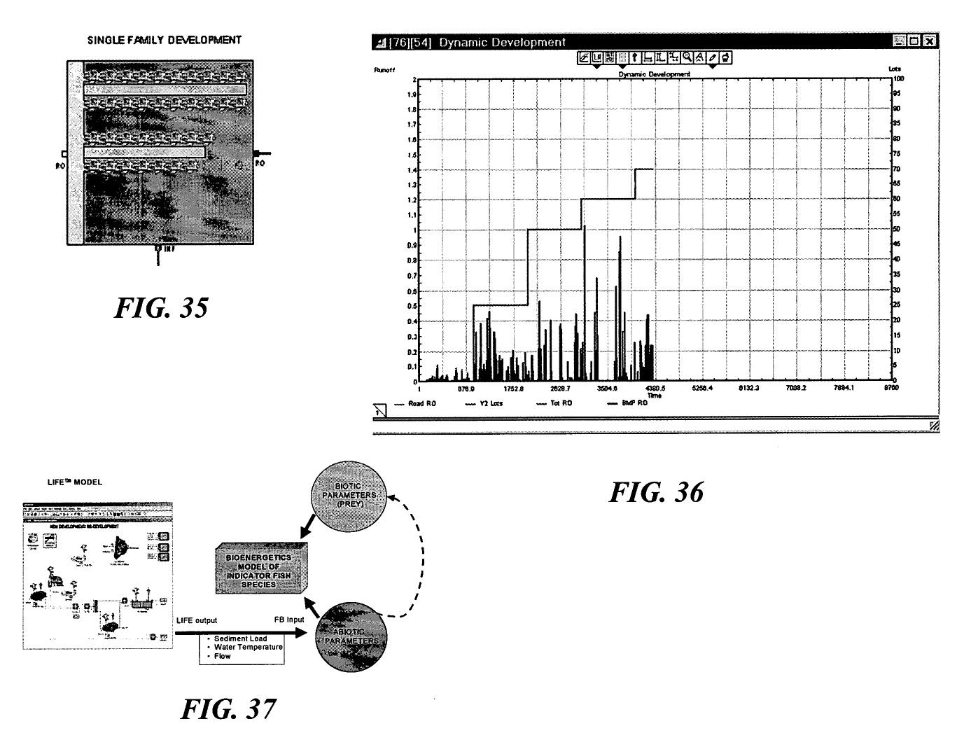

The modeling system may display and update the number of lots in a development throughout the simulation. FIGS. 35 and 36 represent a dynamic development animation for a development hierarchical block in one embodiment. One skilled in the art will appreciate that more elaborate animations can be used, for example, showing the actual layout of the development with the lots.

### Biotics

In some embodiments, the modeling system may be configured to enable a user to predict the effects of land use on aquatic biota. In one such embodiment, a generalized fish bioenergetics (FB) model is combined with the modeling system. By combining the modeling system and a FB model, one can use the modeling system to predict the effects of Low-Impact Development (LID) on the growth of key fish species that serve as general indicators of aquatic ecosystem health, thereby enabling users to quantify the benefits of LID on biota and visualize how LID-based improvements impact the general status of ecosystem system. Additionally, the combined modeling system can be used to evaluate the effects of LID-based water quality controls on fish biota in habitats near the site, identify site-specific best management practices that minimize or reduce the effects of development on biota and their habitat, increase a user's ability to achieve a balance between economic growth and protection of sensitive habitats, and so on. The combined modeling system can further be configured to include parameterization options for a wide range of fish species and their physiological responses (food consumption, respiration) to key variables such as water temperature, which enables the modeling system to be used to predict the effects of LID on fish species from a variety of habitats (streams, ponds, rivers, wetlands).

In one embodiment, the FB model simulates the fish growth process using an energy budget approach in which daily growth equals the difference between energy consumed in food and energy lost via metabolism, egestion (feces), and excretion (urine). In the FB model, these physiological processes are modeled as functions of fish body mass and water temperature. Additionally, the FB model can use existing relationships that describe the effects of other water quality variables (e.g., flow, sediment load, toxins, nutrients, etc.) on fish physiological processes, as well as on its prey resources, to predict fish growth rate. The modeling system's output, which includes water temperature and other water quality variables used in FB model, can be used as the source of input data for the FB model, thereby effectively simulating the effects of land use changes in a watershed on the growth rates of various fish stages (e.g., juveniles and adults).

FIG. 37 illustrates graphically how the modeling system can be combined with a FB model to predict the effects of land use changes on indicator fish species. Outputs from the modeling system include abiotic variables such as sediment load, water temperature, and flow. These output variables provide the environmental data required by the FB model to predict effects on fish growth rate. Additionally, the modeling system may model the effects of these water quality variables on a fish's growth rates indirectly through impacts on the fish's prey resources.

In some embodiments, the modeling system may be combined with a FB model by integrating the FB model into the modeling system. The standard equations describing fish physiological processes and their dependence on fish body mass and water temperature in Hanson et al. (1997) may be stored in the object store and invoked by the simulate component to generate output information about the fish, which can be stored in the output store. In other embodiments, the modeling system may be linked to an existing software package that contains a FB model. One such software package is available from the University of Wisconsin-Sea Grant (Hanson et al. 1997). When the modeling system is linked to an existing software package containing a FB model, the modeling system outputs of physical parameters is fed into the FB model to predict effects on fish growth.

As discussed above, the FB model may be based on an energy budget where specific growth rate (dB/Bdt) is modeled. In the FB model, a fish's growth rate is represented gby the following equation:

$$\frac{ⅆ B}{B ⅆ t} = C - ( R + F + U )$$

where B is the weight of the fish, t is time, C is consumption, R is respiration, F is egestion, and U is excretion. The FB model predicts fish growth on a daily basis.
I. Consumption Component

The FB model models consumption as an allometric function of fish weight, water temperature, and food availability. The FB model determines consumption by the following equations:
C=C_{MAX}□f(T_{c})□P
C_{MAX}=a_{c}□W^{b}^{_{c}}
where a_{c} and b_{c} are the intercept and slope, respectively, that relate maximum consumption rates (C_{MAX}, g/g/d) at the optimal temperature (T_{Co}) to fish wet body mass (W, in grams). C_{MAX} is based on the fact that a fish cannot consume more than its stomach can hold, and consumption rate is therefore bounded by this temperature-dependent maximum consumption. The actual consumption rate (C) is defined as the proportion of maximum consumption (P, value ranges from 0 to 1) realized in the field, which serves as an index of food availability. This P factor may be constant or may be input as a timeseries to reflect the effect of changing habitat conditions. The temperature-dependence function for consumption, f(T_{c}), follows that described for warm-water species (Hanson et al., 1997) as represented by the following equation:
f(T_{c})=(V_{c})^{x}□e^{(X□(1-V}^{_{c}}⁾⁾
where:

$${V}_{C} = \frac{( {T}_{Cm} - T )}{( {T}_{Cm} - {T}_{Co} )}$$

$$X = \frac{( {Z}^{2} • ( 1 + {( \sqrt{( 1 + 40 ) / Y} )}^{2}}{400}$$

$$Z = ln ( CQ ) • ( {T}_{Cm} - {T}_{Co} )$$

$$Y = ln ( CQ ) • ( {T}_{Cm} - {T}_{Co} + 2 )$$

and T is the ambient water temperature, T_{Cm} and T_{Co} are the maximum and optimal temperatures for consumption, and CQ is the Q₁₀ (multiplier by which a rate increases for every 10° C. increase in temperature) for consumption at low water temperatures. One skilled in the art will appreciate that other temperature dependence functions for food consumption may be used. (See, e.g., Hanson et al. 1997.)
II. Respiration (Metabolism) Component

The FB model models respiration rate (R) as an allometric function of body weight, water temperature, fish activity level, and specific dynamic action (SDA). The modeling system represents respiration by the following equation:
R=aᵣ□W^{b}^{ᵣ}□f(T_{R})□A+S□(C−F)
where aᵣ and bᵣ are the intercept and slope, respectively, that describe the relationship between fish body weight (W) and standard respiration rate, f(T_{R}) is the temperature-dependence function for respiration (described below), A is the activity parameter (≧1.0) that specifies rates above standard level, S is the SDA coefficient which is defined as the metabolic cost of digesting and processing consumed energy, and F is specific egestion rate.

The FB model uses a temperature-dependence function for respiration that follows consumption described in eq. 4 (Hanson et al., 1997). The modeling system represents the function by the following equation:
f(T_{R})=(V_{R})^{X}□e^{(X□(1-V}^{_{R}}⁾⁾
where:

$${V}_{R} = \frac{( {T}_{Rm} - T )}{( {T}_{Rm} - {T}_{Ro} )}$$

X is as described in eq. 6 of Hanson,
Z=In(RQ)□(T_{Rm}−T_{Ro})
Y=In(RQ)□(T_{Rm}−T_{Ro}+2)
and T is the ambient water temperature, T_{Rm} and T_{Ro} are the maximum and optimal temperatures for respiration, and RQ approximates the average Q₁₀ for respiration. One skilled in the art will appreciate that other temperature dependence functions for respiration may be used. (See, e.g., Hanson et al. 1997.)
III. Egestion (F) and Excretion (U) Component

The FB model models egestion and excretion as constant proportions of consumption and assimilation, respectively (Hanson et al., 1997). The modeling system represents egestion and excretion by the following equations:
F=a_{f}□C
U=aᵤ□(C−F)
where C, the consumption rate is as described in eq. 2 (Hanson et al., 1997).

Species-specific information on the various physiological parameters can be found in Appendix A in Hanson et al. (1997). This appendix contains information on 55 fish species representing a variety of aquatic habitats ranging from streams, ponds, lakes, estuaries and oceans. Information on additional species can also be found in primary journal literature published after 1997. The modeling system provides a menu-driven “species library” that is continuously updated as new information on other species becomes available.

The modeling system can be used to model a wide variety of fish species for which information on physiological parameters and their relationship to various environmental factors.

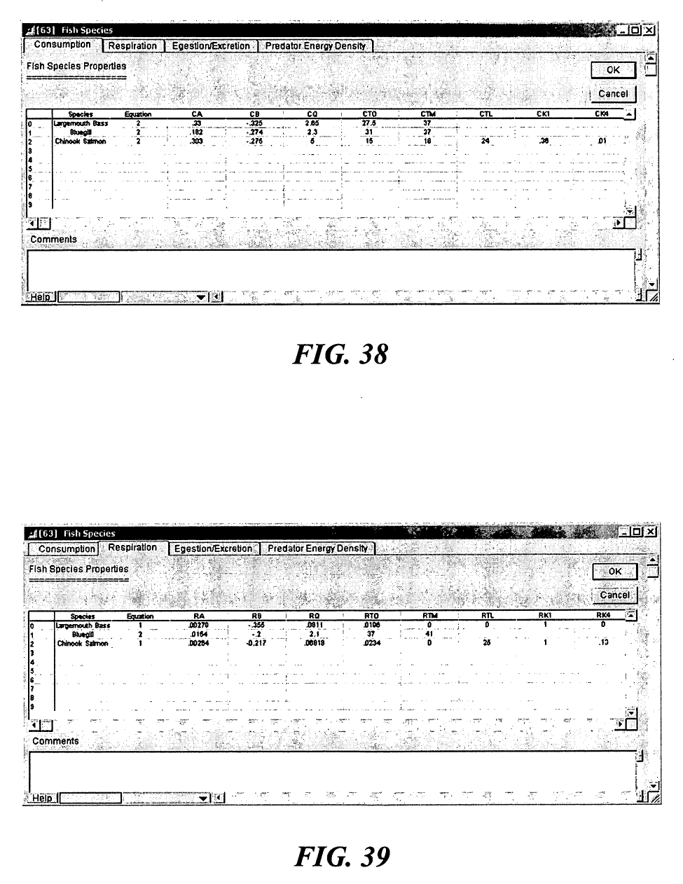

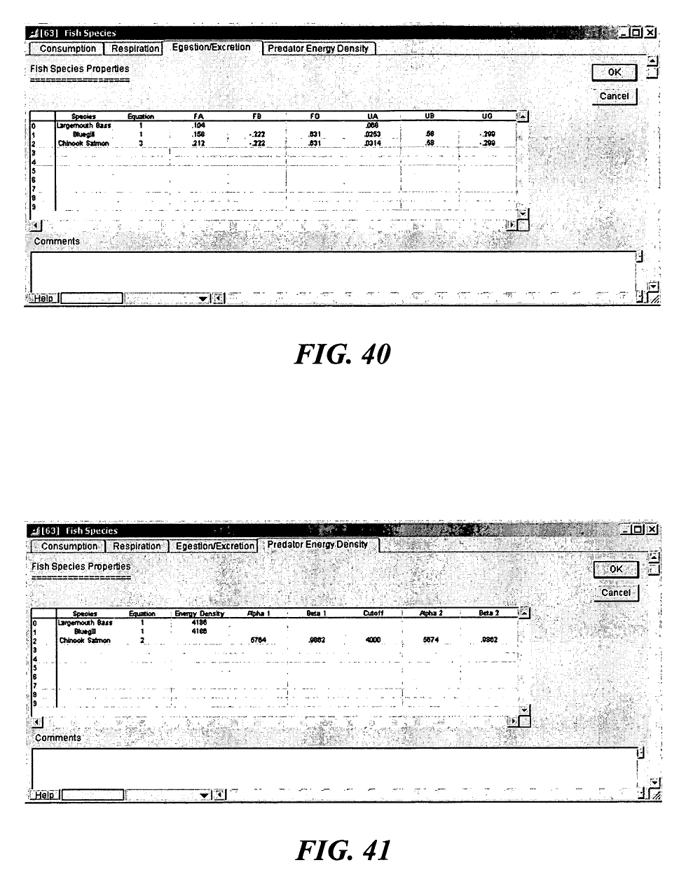

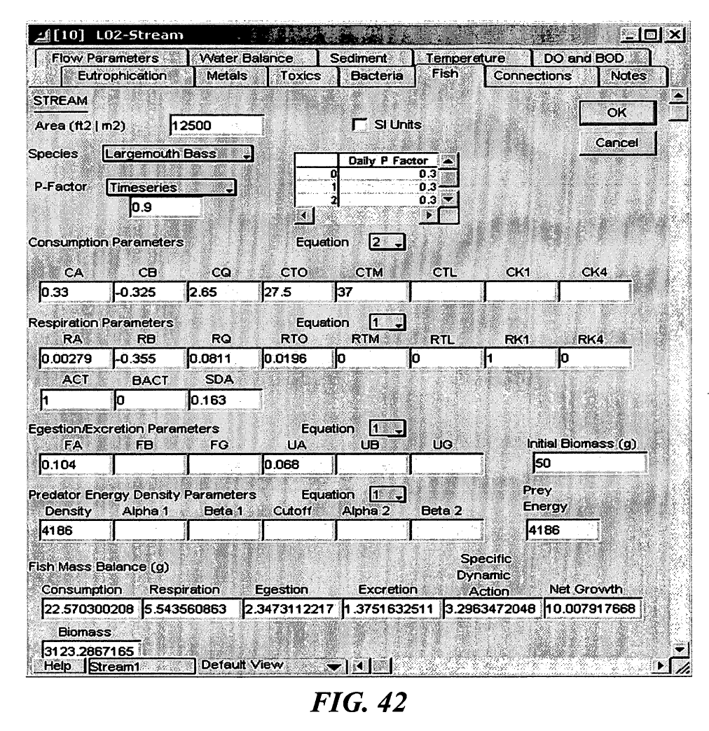

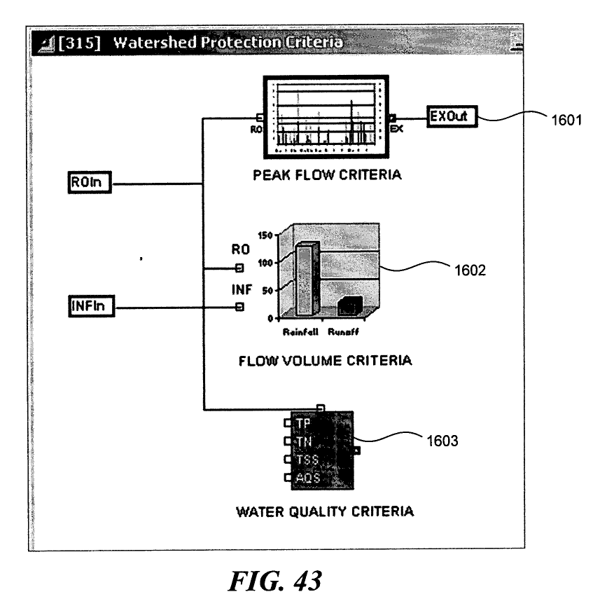

The modeling system provides a user-extensible database of parameter values for each species of fish, including the selection of alternative equations most appropriate for that species. The species database block is global to the entire model, and each stream block currently selects the species represented. If migration from reach to reach is to be modeled, selection of a single species for all stream blocks may be enforced. FIGS. 38-41 illustrate dialog boxes for parameter value relating to egestion and excretion in one embodiment. The “Predator Energy Density” tab can be used to account for differences in caloric value by body mass for predator and prey species. In one embodiment, the modeling system assumes that all species have equal caloric value by body mass. FIG. 42 illustrates a dialog box for fish parameters and balance for a stream in one embodiment.

These parameters are used to track fish biomass in the reach based on stream temperature, using the equations described in the preceding section.

### Water Quality Module

The water quality module may include water quality processes and provide linkage to other water quality models such as SWMM, SWAT, HSPF, and WASP among others. In the full eutrophication algorithm, the DO/BOD cycle may have additional elements. The modeling system may represent change in dissolved oxygen by the following equation:
ΔDO=DO+R−D−SOD−NIT+PGRO−PRES
where ΔDO is change in dissolved oxygen storage, R is reaeration, D is BOD decay loss, SOD is sediment oxygen demand, NIT is nitrification loss, PGRO is oxygen production due to phytoplankton growth, and PRES is oxygen consumption due to plankton respiration.
ΔCBOD=I−O−S−D−DEN+PDTH
where ΔCBOD is change in carbonaceous BOD, I is inflow, O is outflow, S is settling of particulate organic matter, D is BOD decay, DEN is reduction of BOD due to consumption via denitrification by stoichiometric ratio, and PDTH is addition of BOD due to plankton death by stoichiometric ratio.

The modeling system may also use detailed mass-balance tracking of nitrate, ammonia, organic nitrogen, phosphate, organic phosphorus, and phytoplankton as represented by the following equations:
ΔNO3=I−O+NIT−DEN−PGRO*f_{NO3}
where ΔNO3 is change in nitrate storage, I is inflow of nitrate, O is outflow of nitrate, NIT is production of nitrate by nitrification of ammonia, DEN is removal of nitrate by denitrification to N2, PGRO is uptake of nitrogen for phytoplankton growth, by stoichiometric ratio, and f_{NO3} is fraction of nitrogen uptake satisfied by nitrate, and
ΔNH3=I−O+ONM−NIT−PGRO*(1−FNO3)+PDTH*(1−F_{ON})
where ΔNH3 is change in ammonia storage, I is inflow of ammonia, O is outflow of ammonia, ONM is production of ammonia due to organic N mineralization, NIT is removal of ammonia by nitrification to nitrate, PGRO is uptake of nitrogen for phytoplankton growth, by stoichiometric ratio, PDTH is release of nitrogen due to phytoplankton death and FON is fraction of nitrogen released as organic N due to phytoplankton death, and
ΔON=I−O−NSET−ONM+PDTH*F_{ON}
where ΔON is change in organic nitrogen storage, I is inflow of organic nitrogen, O is outflow of organic nitrogen, NSET is settling of organic nitrogen, ONM is bacterial mineralization of organic nitrogen to ammonia, PDTH is release of nitrogen due to phytoplankton death, and F_{ON} is fraction of nitrogen released as organic N due to phytoplankton death, and
ΔPO4=I−O+OPM−PGRO+PDTH*(1−F_{OP})
where ΔPO4 is change in phosphate storage, I is inflow of phosphate, O is outflow of phosphate, OPM is production of phosphate due to organic phosphorus mineralization, PGRO is uptake of phosphate for phytoplankton growth, by stoichiometric ratio, PDTH is release of phosphorus due to phytoplankton death, and F_{OP} is fraction of phosphorus released as organic phosphorus due to phytoplankton death, and
ΔOP=I−O−PSET−OPM+PDTH*F_{OP}
where ΔOP is change in organic phosphorus storage, I is inflow of organic phosphorus, O is outflow of organic phosphorus, PSET is settling of organic phosphorus, OPM is bacterial mineralization of organic phosphorus to phosphate, PDTH is release of phosphorus due to phytoplankton death, and F_{OP} is fraction of phosphorus released as organic phosphorus due to phytoplankton death, and
ΔP=PGRO−PRES−PDTH−PSET
where ΔP is change in phytoplankton biomass, PGRO is phytoplankton growth, PRES is phytoplankton respiration, PDTH is phytoplankton death, and PSET is phytoplankton settling.

Of the above processes, many are specified as simple first-order rates, with a standard Arrhenius temperature correction based on 20° C. represented by the following equation:
K_{eff}=K₂₀*θ^{(T}^{_{w}}^{W-20)}
where K_{eff} is effective first-order rate, K₂₀ is nominal first-order rate at 20° C., θ is temperature correction coefficient, and T_{w} is water temperature. This equation is used for BOD decay, sediment oxygen demand, nitrification, organic nitrogen and phosphorus mineralization, phytoplankton death, and phytoplankton respiration. The BOD, organic match can and phosphorus, and phytoplankton may be allowed to settle out at a given fall velocity. The modeling system allows separate rates to be given for organics and phytoplankton. The modeling system calculates the removal using the following equations:
S=v_{f}/d
where S is fraction of material settling out, v_{f} is fall velocity of material, and d is depth.

The modeling system may simulate denitrification as a first-order rate with a maximum DO concentration or be supplemented with a half-saturation constant using the following equation:
K_{eff}=K₂*θ^{(T}^{_{w}}⁻²⁰⁾*[C_{den}/(C_{den}+DO)]
where K_{eff} is effective first-order rate, K₂₀ is nominal first-order rate at 20° C., θ is temperature correction coefficient, T_{w} is water temperature, C_{den} is denitrification half-saturation constant for dissolved oxygen, and DO is dissolved oxygen concentration.

The modeling system may allow the inclusion of a half-saturation constant for each of these to allow for feedback effects. The modeling system may represent the first order equation by the following equation:
K_{eff}=K₂₀*θ^{(T}^{_{w}}⁻²⁾* [C/(Cₕₛ+C)]
Where K_{eff} is effective first-order rate, K₂₀ is nominal first-order rate at 20° C., θ is temperature correction coefficient, T_{w} is water temperature, C is concentration of limiting constituent (e.g., NH3 for nitrification), and Cₕₛ is half-saturation constant.

Also, a reduction of BOD decay and nitrification may occur due to low concentrations of available DO, in which case an additional half-saturation factor is added with DO as the limiting constituent. Such factors are built into the WASP “non-linear DO balance” option.

The modeling system represents the overall phytoplankton growth expression by the following equation:
K_{eff}=K₂₀*θ^{(T}^{_{w}}⁻²⁰⁾*min{[DIN/(C_{N}+DIN)], [PO4/(C_{P}+PO4)], [I/(C_{I}+I)]}
where K_{eff} is effective first-order growth rate, K₂₀ is nominal first-order growth rate at 20° C., θ is temperature correction coefficient, T_{w} is water temperature, DIN is concentration of available nitrate plus ammonia, C_{N} is half-saturation constant for nitrogen, PO4 is concentration of phosphate, C_{P} is half-saturation constant for phosphorus, I is average light intensity, and C_{I} is half-saturation constant for light. The modeling system may calculate the average light intensity as a function of incoming solar radiation and light extinction, roughly as in HSPF as represented by the following equation:
I=R*exp(−Cₑ*0.5*min(dₑ,d))
Where I is average light intensity for phytoplankton growth, R is solar radiation, Cₑ is total light extinction coefficient, dₑ is euphotic depth, and d is stream depth. The euphotic depth is the depth at which available light is 1% of the incoming solar radiation. The modeling system may represent the euphotic depth by the following equation:
dₑ=In(100)/Cₑ
where dₑ, is euphotic depth and Cₑ is total light extinction coefficient.

Adsorption/desorption of NH3 and PO4 may use partitioning coefficients. Because the rate of these processes in the water column is on the order of minutes rather than the days typical of biological processes, the modeling system may assume that equilibrium is reached instantaneously.

The modeling system may use the HSPF method of scouring adsorbed nutrients at low and high areal rates depending on velocity. The modeling system may maintain a bed nutrient balance.

The modeling system may also be adapted to address how wetland WQ behavior differs from normal instream processes (e.g., macrophyte uptake, anaerobic reactions in sediments, etc.).

### Web Interface for Client Access

The modeling system may be implemented on a web-based platform for remote user access. Users who have developed a model using the modeling system can access it via a secure web site, and can then run simulations, modify inputs, and view results remotely from their local office computers. Users who access the modeling via the web can utilize it without needing to write software code, maintain data sets, or purchase redundant software licenses.

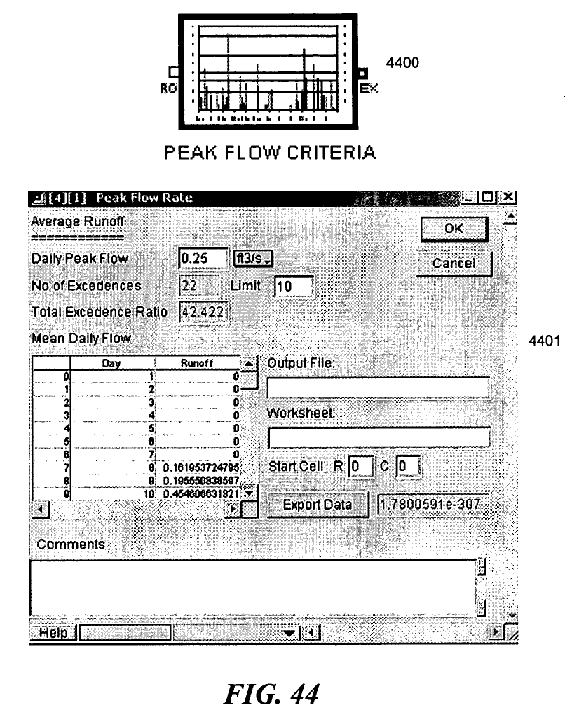

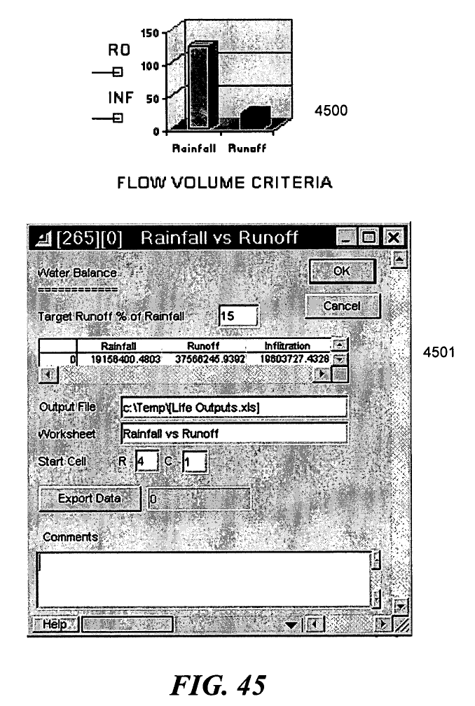

FIG. 43 illustrates a display page for the setting of watershed protection criteria in one embodiment. The modeling system displays this page when a user selects a watershed protection criteria icon, such as icon 115 of FIG. 1. When the user selects icon 4301, the modeling system displays a peak flow criteria dialog box for the development. When the user selects icon 4302, the modeling system displays volume flow criteria dialog box for the development. When the user selects icon 4303, the modeling system displays a water quality criteria dialog box for the development. FIG. 44 illustrates peak flow criteria information. When the user selects icon 4400, the modeling system displays dialog box 4401. The dialog box 4401 contains daily peak flow rate information fields including a number of exceedances field, a total exceedance ratio field, and a mean daily flow field. A user can specify the daily peak flow rate and the limitation on the number of exceedances that can be allowed while still meeting the criteria of watershed protection. The dialog box also allows this information to be exported to a spreadsheet. FIG. 45 illustrates flow volume of criteria information. When the user selects icon 4500, the modeling system displays dialog box 4501. The dialog box 4501 contains the water balance fields for the development including a target runoff percent of rainfall field that is set by a user, a total rainfall field, a total runoff field, and a total infiltration field. When a user selects the water quality criteria icon 4303, the modeling system displays a dialog box (not shown) that allows the user to specify the limits on total phosphates, total nitrogen, total suspended sediment, aquatic score (e.g., safe for fish), and so on.

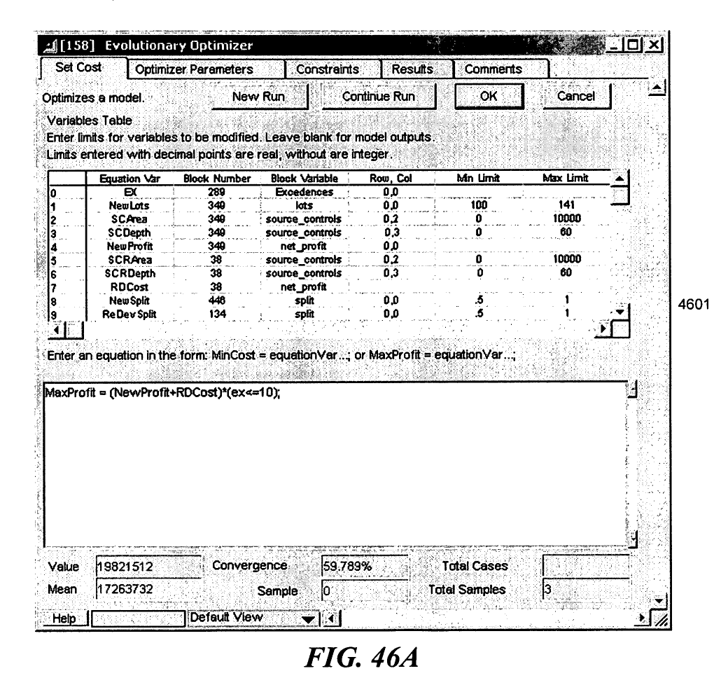

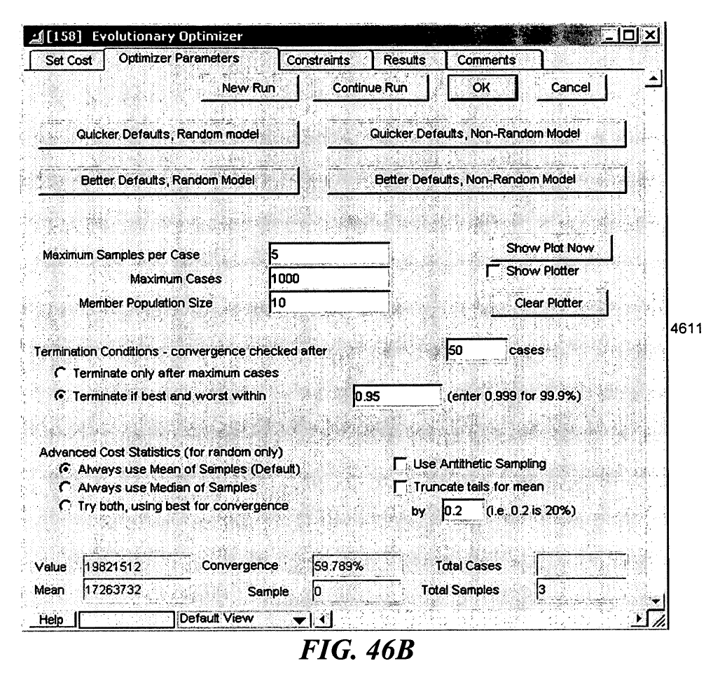

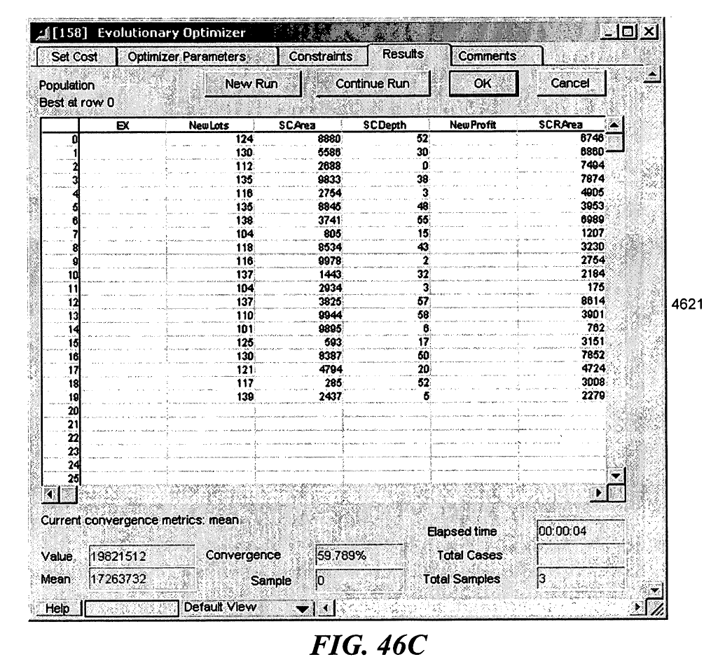

FIGS. 46A-46C are dialog boxes for the optimization process. These dialog boxes are standard dialog boxes provided by an optimization system such as the Extend Evolutionary Optimizer. Dialog box 4601 displays the constraints or limits for the optimization that are used for this example. These constraints can be modified depending on the application. In the example, row 4602 specifies that the number of lots is constrained to between 100 and 141. Equation box 4603 allows the user to specify the objective function. In this example, the objection function is maximum profit. Dialog box 4611 displays various options for controlling the optimization process. Dialog box 4621 displays the maximum profit calculated for each simulation with a different set of parameters. The values of the constrained parameters for each simulation can be viewed by scrolling to the right.

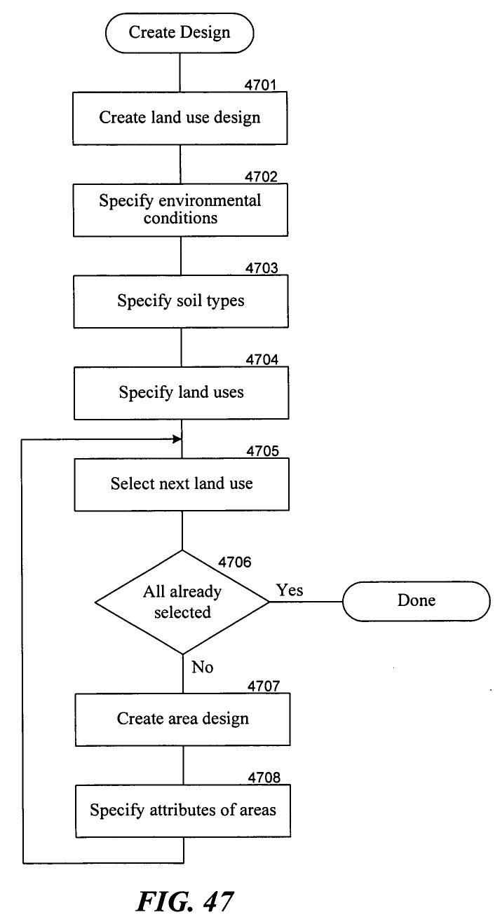

FIGS. 47-55 are flow diagrams illustrating the processing of the modeling system in one embodiment. FIG. 47 is a flow diagram of the create design component in one embodiment. The create design component controls the user interface for creating the graphical representation of the development designs and setting of the attributes of the designs. In block 4701, the component creates a land-use design based on user input. A user may select various land-use icons and place them on the display page and then indicate the dependencies of the land uses. In block 4702, the component allows a user to specify the environmental conditions, such as rainfall and evapotranspiration, for the development. In block 4703, the component allows the user to specify the possible soil types for the development. In block 4704, the component allows the user to specify the attributes of the land uses. In blocks 4705-4708, the component loops selecting each land use and creating a detailed design of the areas within that land use. In block 4705, the component selects the next land use. In decision block 4706, if all the land uses have already been selected, then the component completes, else the component continues at block 4707. In block 4707, the component creates the detailed area design for the selected land use. The component allows a user to place area icons on the display representing the areas of the selected land use. The user interconnects the icons to indicate the dependencies of the water flow. In block 4708, the component specifies the attributes of each area. The component then loops to block 4705 to select the next land use.

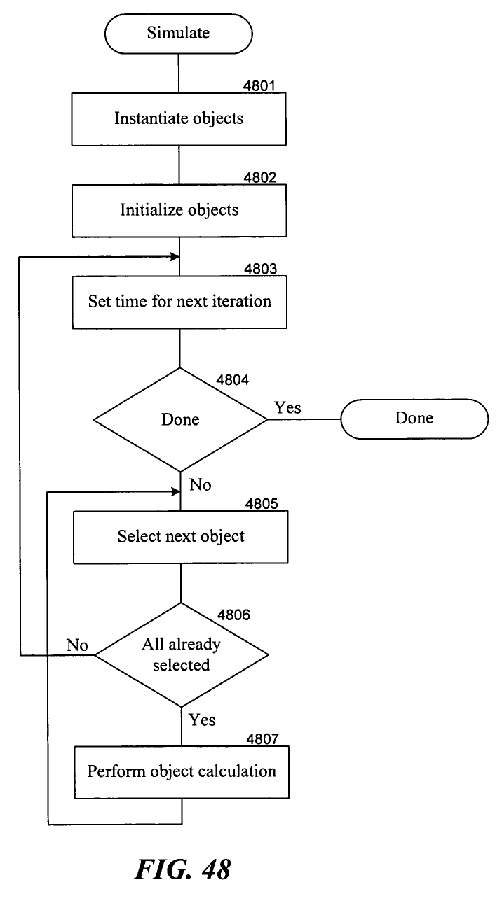

FIG. 48 is a block diagram illustrating the simulate component in one embodiment. The component initializes the objects for the simulation and then iteratively invokes the components for each interval of the iteration period. In block 4801, the component instantiates an object for each icon of the development design. In block 4802, the component initializes each object. The initialization of an object allows for processing that needs to be performed at the start up of the simulation. For example, a rainfall object may load rainfall information and store it in an array in memory. In blocks 4803-4807, the component loops performing each iteration. In block 4803, the component sets the time for the next iteration. In decision block 4804, if the time is passed the end of the simulation, then the component completes, else the component continues at block 4805. In blocks 4805-4807, the component loops performing the calculation for each object in dependency order. In block 4805, the component selects the next object in dependency order. In decision block 4806, if all the objects have already been selected, then the component loops to block 4803 to perform the next iteration, else the component continues at block 4807. In block 4807, the component invokes a method of the object to perform its simulation calculation. In one embodiment, the objects may be a classic object-oriented type objects with a simulation method, an initialize simulation method, and so on. The component then loops to block 4805 to select the next object.

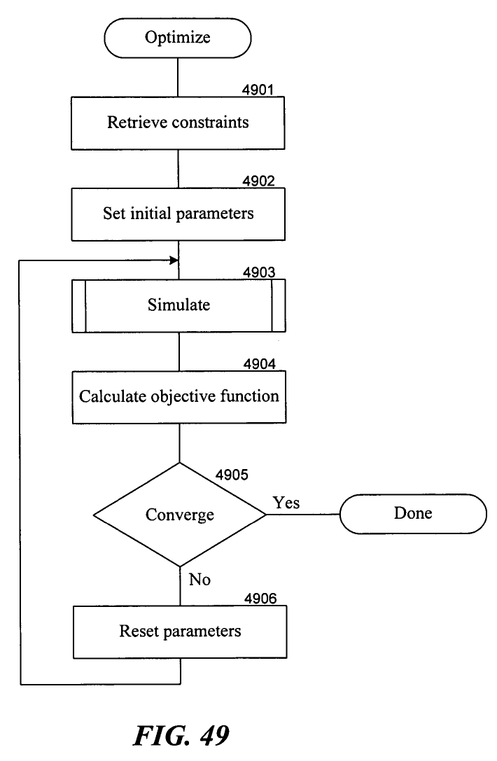

FIG. 49 is a flow diagram illustrating the optimize component in one embodiment. The optimize component sets initial parameters for the simulation and then performs the simulation. The component then calculates an objective function, resets the parameters based on the value of the objective function, and performs the simulation again. This process is repeated until the results of the objective function converge to an optimal solution. In block 4901, the component retrieves the user specified constraints for the optimization. In block 4902, the component sets the initial parameters within the constraints for the simulation. In block 4903, the component performs the simulation based on the current parameters. In block 4904, the component calculates the objective function based on the results of the simulation. In decision block 4905, if the results of the objective function converges on a solution, then the component completes, else the component continues at block 4906. In block 4906, the component resets the parameters based on the results of the objective function and then loops to block 4903 to perform the simulation again.

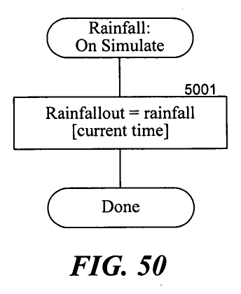

FIGS. 50-55 are flow diagrams illustrating calculations of example objects in one embodiment. FIG. 50 is a flow diagram illustrating the calculations performed by a rainfall object. The input to the simulation includes the rainfall data on a periodic basis. In block 5001, if the simulation interval is the same as a periodic basis of the rainfall, then the component retrieves the rainfall amount for the current time and designates it as the output rainfall of the object, which serves as an inflow to the areas. Alternatively, if the simulation interval and the periodic basis for the rainfall are not the same, then the component adjusts the rainfall amounts to correspond to the interval. For example, if the periodic basis of the rainfall is hourly, but the simulation interval is daily, then the component may need to aggregate the rainfall total for each day from the hourly amounts.

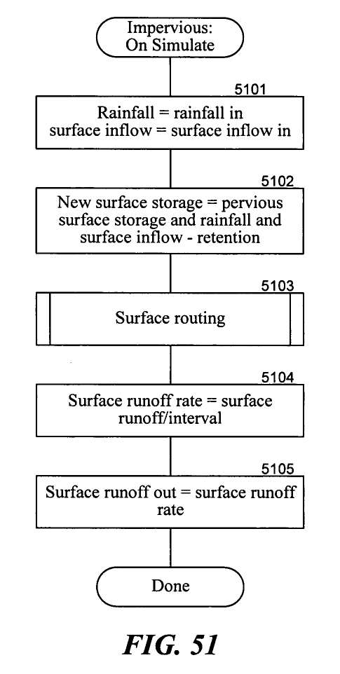

FIG. 51 is a flow diagram illustrating the calculations performed by an impervious object, such as a roof object. In block 5101, the component retrieves the rainfall in information for the interval provided by the rainfall object and surface inflow in information that may be provided by an upgradient block. The rainfall in information may be in total inches of rainfall for the interval. In block 5102, the component calculates the water available for runoff by adding any preexisting surface storage to the rainfall and surface inflows, and subtracting the retention storage capacity. In block 5103, the component calculates the actual runoff of the available water. In block 5104, the component sets the runoff rate to the current runoff divided by the interval. In block 5105, the component sets the runoff out for this object to the runoff rate and then completes.

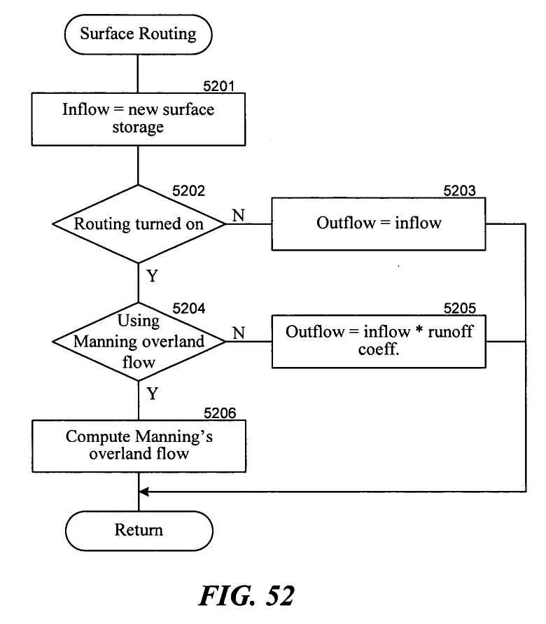

FIG. 52 is a flow diagram illustrating the calculations performed by the surface routing component of a land area block in one embodiment. In block 5201, the component retrieves the inflow depth. In decision block 5202, if the user has chosen to use surface routing, then the component goes to block 5204, else the component goes to decision block 5203. In block 5203, the component sets the routed outflow equal to the inflow and then returns. In decision block 5204, if the user has chosen to use Manning's overland flow, then the component goes to block 5206, else the component goes to block 5205. In block 5205, the component sets the outflow to the inflow multiplied by a runoff coefficient and then returns. In block 5206, the component computes the Manning's overland flow and then returns.

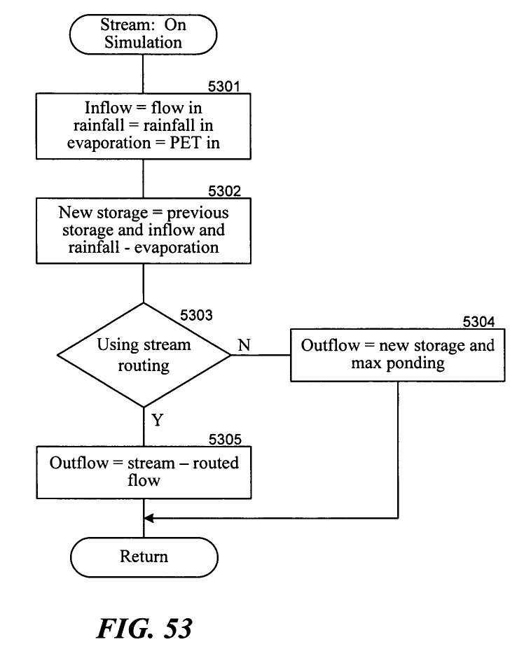

FIG. 53 is a flow diagram illustrating the calculations performed by the stream object in one embodiment. In block 5301, the component retrieves the rainfall in information for the interval provided by the rainfall object, the evaporation in for the interval provided by the evaporation object, and the surface inflow, which may be provided by any number of upgradient land and stream type objects. In block 5302, the component computes the updated storage by adding the rainfall and inflow and subtracting the evaporation. In decision block 5303, if the user has selected to use stream routing, then the component continues at block 5305, else the component continues at block 5304. In block 5304, the component computes the outflow as the excess storage above the maximum ponding depth and returns. In block 5305, the component calculates the outflow based on the stream routing algorithm and returns.

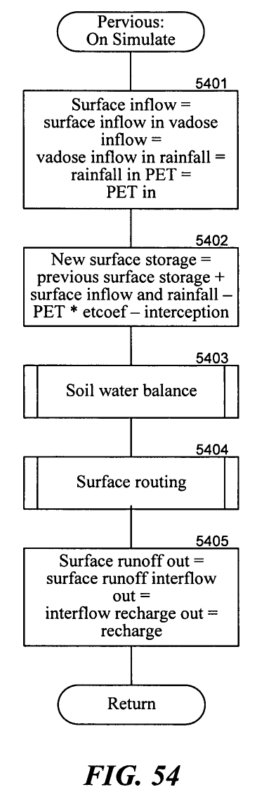

FIG. 54 is a flow diagram illustrating the processing of the calculations performed by the pervious component in one embodiment. In block 5401, the component retrieves the input parameters of surface inflow, vadose inflow, rainfall, and potential evapotranspiration. In block 5402, the component computes the new surface storage as the previous storage plus rainfall and surface inflow, minus interception and the potential ET multiplied by an ET coefficient. In block 5403, the component invokes the component to calculate the soil water balance. In block 5404, the component invokes the component to calculate surface runoff routing. In block 5405, the component sets the output for the object as surface runoff, interflow, and recharge and returns.

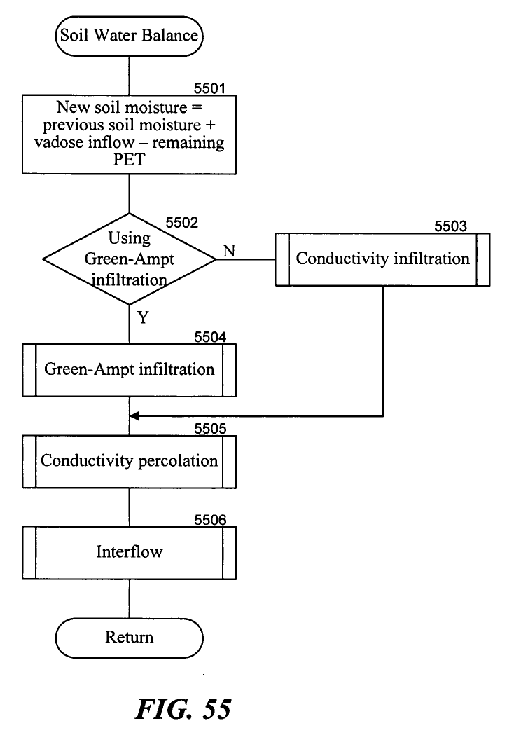

FIG. 55 is a flow diagram illustrating processing of the calculations performed by the soil water balance component of the pervious object in one embodiment. In block 5501, the component computes new soil moisture as the previous soil moisture plus vadose inflow minus the remaining potential ET after any surface ET is taken in block 5402. In decision block 5502, if the user has selected the Green-Ampt infiltration algorithm, then the component continues at block 5504, else the component continues at block 5503. In block 5503, the component performs the conductivity infiltration algorithm to compute infiltration and new soil moisture and surface storages. In block 5504, the component performs the Green-Ampt infiltration algorithm to compute infiltration and new soil moisture and surface storages. In block 5505, the component performs the conductivity percolation algorithm to compute recharge and new soil moisture storage. In block 5506, the component performs the interflow algorithm to compute the interflow and new soil moisture storage. The component then returns.

One skilled in the art will appreciate that although specific embodiments of the modeling system have been described herein for purposes of illustration, various modifications may be made without deviating from the spirit and scope of the invention. One skilled in the art will appreciate that the simulations can be performed based on a development design that may be specified with or without a graphical tool. For example, the design may be specified by a user using a text editor to specify the areas, attributes, and dependencies. One skilled in the art will appreciate that the modeling system can accommodate any size of area under consideration (from regional watershed to a few acres in a housing development), a temporal resolution appropriate to the problem being addressed, best management practices algorithms that compute the retention processes under different loading (e.g., rainfall) conditions to provide more realistic estimates of efficacy, and uncertainty calculations based on the statistical distribution of parameters. One skilled in the art will appreciate that the modeling system has multiple uses, including the design of volume or water quality based stormwater controls and best management practices and the evaluation of the effects of LID controls on runoff volume, peak flows, water quality, and habitat. Accordingly, the invention is not limited except by the appended claims.

1. A method in a computer system for modeling transport of sediment from a site having various areas of different land uses and various sources of water, the method comprising:
generating a graphical representation of the flow of water dependencies of areas and sources of water of the site, the dependencies indicating an outflow from an area or source of water to an inflow of an area;
receiving attributes describing each area and each source of water, including sediment information; and
performing a simulation of out flow of water and sediment between areas and source for each of a plurality of time increments.

2. The method of claim 1 wherein the outflow of sediment from a pervious area is calculated based on surface runoff volume, peak runoff rate, size of area, and sediment parameters.

3. The method of claim 2 wherein the sediment parameters are selected from the group consisting of soil erodibility factor, topographic factor, cover and management factor, and coarse fragment factor.

4. The method of claim 1 wherein the outflow of sediment arriving at a stream factors in a delivery ratio.

5. The method of claim 1 wherein the outflow of sediment from a pervious area is represented by the following equation:
Xₜ=11.8*(Q*qₚₖ*A)^{0.56}*K*(LS)*C*P*CFRG
where Xₜ is sediment generated on time step t, Q is surface runoff volume, qₚₖ is peak runoff rate, A is area of the pervious block, K is USLE soil erodibility factor, LS is USLE topographic factor, C is USLE cover and management factor, P is USLE support practice factor, and CFRG is coarse fragment factor.

6. The method of claim 1 wherein the outflow of sediment from an impervious area is calculated based on sediment buildup, washoff rate, rainfall intensity and duration, and availability factor.

7. The method of claim 1 wherein the outflow of sediment from an impervious area is represented by the following equation:
W=AᵥW₀(1−e^{-k}^{₂}^{rj})
where W is impervious sediment washoff, Aᵥ is availability factor, W₀ is initial sediment load, k₂ is washoff rate, r is rainfall intensity, and j is rain duration.

8. The method of claim 1 wherein the outflow of sediment from an impervious area is represented by the following equation:
W=W₀(1−e^{-kqj})
where W is impervious sediment washoff, W₀ is initial sediment load, k is washoff rate, q is surface runoff depth, and j is timestep duration.

9. The method of claim 1 wherein the outflow of sediment from a source of water is calculated as the maximum transport capacity when the existing concentration is greater than the maximum transport capacity and as the existing concentration plus scour from the source when the existing concentration is less than the maximum transport capacity.

10. The method of claim 1 wherein the outflow of sediment from a source of water is calculated based on maximum transport capacity represented by the following equation:
Cₘₐₓ=Kₛv^{Es}
where Cₘₐₓ is maximum transport capacity, Kₛ is user-defined sediment transport coefficient, v is water velocity, and Eₛ is a user-defined sediment transport exponent.

11. The method of claim 1 wherein the outflow of sediment from any land use is based on whether the land use is pervious or impervious.

12. The method of claim 1 wherein the performing of the simulation includes:
calculating the outflow of each source of water and sediment for that time increment based on the attributes of the source of water; and
calculating the outflow of each area for that time increment based on the inflows of water and sediment and attributes of that area.

13. A method in a computer system for modeling flow of water of a site having areas with dynamic land use and sources of water, the method comprising:
generating a graphical representation of the flow of water dependencies of areas and sources of water of the site, the dependencies indicating an outflow from an area or source of water to an inflow of an area;
receiving attributes describing each area and each source of water, the attributes varying over time; and
performing a simulation of flow of water over of time increments that factor in the attributes that vary over the time increments.

14. The method of claim 13 wherein the attributes indicate areas devoted to specific land uses at specific times.

15. The method of claim 13 wherein the attributes specify whether a land use is pervious or impervious.

16. The method of claim 13 wherein a housing development is modeled and the attributes specify timing of development of lots of the housing development.

17. The method of claim 13 wherein the performing of the simulation includes at each time increment:
calculating the outflow of each source of water quantity and quality for that time increment based on the attributes associated with that time of the source of water; and
calculating the outflow of each area for that time increment based on the inflows and attributes of that area associated with that time.

18. A method in a computer system for modeling effects on aquatic life of land uses of a site having areas of each land use and sources of water, the method comprising:
generating a graphical representation of the flow of water dependencies of areas and sources of water of the site, the dependencies indicating an outflow from an area or source of water to an inflow of an area;
receiving attributes describing each area and each source of water, the attributes of a source of water quantity and quality relating to aquatic life; and
performing a simulation of flow of water for each of a plurality of time increments and effects of the flow on aquatic life that factors in the attributes of the aquatic life of a source of water.

19. The method of claim 18 wherein the performing of the simulation includes for time increments:
calculating the outflow of each source of water for that time increment based on the attributes of the source of water;
calculating the outflow of each area for that time increment based on the inflows and attributes of that area; and
calculating the effect of inflows on the aquatic life within a source of water.

20. The method of claim 18 wherein the attributes of aquatic life are factored in using a fish bioenergetics model.

21. The method of claim 20 wherein the fish bioenergetics model simulates fish growth.

22. The method of claim 21 wherein the fish growth is simulated based on energy consumption and enter lost via metabolism, egestion, and excretion.
